(19) United States
(12) Patent Application Publication
(10) Pub. No.: US 2012/0077160 A1
(43) Pub. Date: Mar. 29, 2012

(54) COMPUTER-IMPLEMENTED INTERACTIVE BEHAVIORAL TRAINING TECHNIQUE FOR THE OPTIMIZATION OF ATTENTION OR REMEDIATION OF DISORDERS OF ATTENTION

(76) Inventors: Joseph DeGutis, Brookline, MA (US); Thomas Van Vleet, El Cerrito, CA (US)

(21) Appl. No.: 13/068,850

(22) Filed: Jun. 27, 2011

Related U.S. Application Data
(60) Provisional application No. 61/344,302, filed on Jun. 25, 2010.

(51) Int. Cl. G09B 19/00

(52) U.S. Cl. 434/236

(57) ABSTRACT

The current invention provides methods of enhancing a subject's attentional state. The methods comprise a series of interactive behavioral assessments and interactive behavioral training sessions, which trains the individual to be in a more optimal attentional state throughout their day-to-day life, ultimately enhancing their cognitive performance, visuomotor performance, and emotion regulation.

### RELATED APPLICATIONS

This application claims priority to U.S. provisional application No. 61/344,302, filed on Jun. 25, 2010, which is incorporated by reference herein in its entirety.

### GOVERNMENT INTERESTS

The present invention was made with U.S. Government support under Grant Number, 05-09-00371, awarded by the Department of Veterans Affairs. The U.S. Government has certain rights to this invention.

### FIELD OF INVENTION

This application relates to a computer-implemented, interactive behavioral training system for enhancing an individual's attentional state. Specifically, it involves an interactive computer-based training system that may be administered to enhance normal attention functioning, and therefore cognition, in some cases into the superior range. Moreover, this system can be used to improve cognitive functioning in neurologic and psychiatric patient populations suffering from dysregulated arousal, impairments in sustaining attention, problems with attentional control such as high distractibility, impairments in shifting attention, and inhibiting inappropriate responses. Thus, this training system could be useful for, but is not limited to, neurologically healthy individuals, individuals suffering from hemispatial neglect, attention deficit hyperactivity disorder, traumatic brain injury, post-traumatic stress disorder, age-related cognitive decline, depression, Down's syndrome, schizophrenia and disorders of sleep regulation such as narcolepsy.

### BACKGROUND OF INVENTION

Attentional state is defined as the quality of one's engagement with their thoughts, emotions, and external environment and one's attentional state fluctuates on the order of fractions of minutes to hours. One's attentional state underlies and interacts with higher-level cognitive functions such as decision-making, motor control, and memory. Thus, enhancing one's attentional state can improve cognitive performance across many domains. Several attentional states have been well-characterized and can be thought of as occurring along a continuum of alertness (see FIG. 1). At the one extreme of the continuum, there are states of mental fatigue, boredom, and dissociation/disengagement from one's environment, which are associated with poor cognitive performance. On the other end are states of anxiety, distractibility and hyper-vigilance to one's environment. These states of higher alertness (also called explorative states by neuroscientists) may be useful when performing very simple cognitive tasks or when monitoring the environment for potential threats over a short period of time. However, these states of high alertness have shown to be temporally unstable and are not typically associated with a high level of cognitive functioning over a sustained period of time. An attentional state in the midrange of alertness is more stable and optimal for higher-level cognitive performance, such as complex decision-making, motor control, and memory. Within this midrange, so-called optimal attentional states often manifest, as when an individual is fully immersed in their current activity with great focus and action is experienced as less effortful. This attentional state is often referred to as “being in the zone,” “being present,” or being in a state of “flow,” or by some neuroscientists as being in an “exploitative” state. The current application relates to interactive behavioral training regimes and methods for engendering this more optimal attentional state.

Behavioral and Physiological Characteristics of the Optimal Attentional State

This more optimal attentional state that the current invention seeks to foster has three main behavioral characteristics: a moderate amount of alertness; improved focus and freedom from distraction; and behavioral control and flexibility.

First, a moderate level of alertness is defined by a dynamic balance between the sympathetic and parasympathetic systems, which manifests in the individual being alert and ready, yet in a relaxed physiological state. This allows the individual to function in the optimal range of the Yerkes-Dodson inverted U-shaped alertness/performance curve (see FIG. 1). With this moderate level of alertness, an individual can sustain a consistent high level of cognitive engagement over tens of minutes to hours without becoming overly fatigued.

Second, improved focus and freedom from distraction are characterized by an enhanced ability to stay on task and less susceptibility to distraction from internally experienced thoughts and emotions or irrelevant information in one's external environment. In a more optimal attentional state improved focus also allows an individual to more easily reorient attention back to the relevant task following distraction.

Finally, behavioral control and flexibility are characterized by the ability to make moment-to-moment adjustments to one's actions based on the changing task demands and one's current goals. This greater control and behavioral flexibility is in contrast to an inflexible, rigid attentional focus that does not change with the changing environment and task demands.

This optimal attentional state that the current invention seeks to foster has behavioral, physiological, neurophysiological, and pharmacological signatures. Behaviorally, this manifests as less variability in performance (i.e., reaction time and accuracy) when performing a task for a sustained amount of time, decreased performance decrement over time, greater short-term memory capacity, improved decision-making ability, enhanced learning ability, increased capacity to regulate one's emotional responses, enhanced spatial attention, and improved motor control.

Physiologically, this optimal attentional state is reflected in a dynamic balance between sympathetic and parasympathetic nervous system activity, which can be observed by measuring skin conductance (typically lower levels of skin conductance), respiratory rate (typically <15 breaths/min, greater volume and/or deeper breathing), heart rate (lower baseline heart rate, increased heart rate variability), and pupil dilation (decreased baseline pupil dilation, increased task-evoked pupillary responses to salient information).

Neurophysiologically, this optimal attentional state is reflected in the neural activity in the locus coeruleus (LC), a brainstem nucleus intimately involved in alertness, attention, and sleep regulation. Firing rates of LC neurons have shown to differentiate between distinct attentional states: a) An exploitative or phasic state in which the animal finds the current task rewarding, is focused on the task, and performing well cognitively; and b) an explorative or tonic state in which the animal finds the current task less rewarding and is seeking other, more rewarding tasks. This explorative state is associated with increased distractibility and poorer cognitive performance. The attentional state that the current invention promotes is more associated with the exploitative/phasic state than explorative/tonic state.

Human neuroimaging studies have also shown several neural signatures associated with this optimal attentional state. Studies using functional magnetic resonance image (fMRI) have shown that an optimal attentional state is associated with more efficient engagement of the fronto-parietal network, a network of brain regions intimately involved in sustained alertness, inhibitory control, as well as the controlled allocation of attention. This optimal state may also be related to improved default mode network functioning (a network of brain regions engaged when the individual is at rest) and a stronger coupling between the default mode network and the task-related fronto-parietal network. Furthermore, this optimal attentional state may be associated with efficient recruitment of anterior cingulate and medial frontal cortices involved in processing stimulus salience. Additionally, neuroimaging studies show that during more optimal attentional states, emotionally evocative stimuli or thoughts do not over-engage the amygdala, an indication of greater emotion regulation.

Human neurophysiology studies examining event-related potentials (ERPs) have shown that an optimal attentional state is associated with a larger positive potential at frontal electrodes approximately 300 ms after the presentation of a relevant stimulus (P300b), indicating more efficient processing of relevant information. Additionally, studies have shown that reduced trial-to-trial variability of stimulus-evoked neural responses is related to an optimal attentional state. Furthermore, a larger late positive potential (>650 ms after stimulus onset) over right parietal regions has been shown to be associated with an optimal attentional state.

Neuropharmacologically, this optimal attentional state is reflected in a balance within norepinephine (NE) and dopamine (DA) neurotransmitter systems. Both neurotransmitter systems show an inverted U-shaped function with cognitive performance: either too little or too much NE or DA impairs cognitive performance. In particular, moderate levels of NE have beneficial effects at post-synaptic noradrenergic alpha-2A receptors, such as increasing local and long-range connectivity in the prefrontal cortex shown to be associated with improvements in working memory. However, high levels of NE, as may occur with states of stress and anxiety, stimulate alpha-1 and beta noradrenergic receptors and have detrimental actions on working memory and prefrontal cortical functioning. Similar to NE, a moderate level of DA is associated with enhanced cognitive performance and optimal functioning of the prefrontal cortex. Moderate levels of DA have shown to improve spatial working memory by reducing prefrontal cortex firing to distractor stimuli. DA can exhibit both beneficial and detrimental effects at D1/D5 receptors depending upon the current state: when an individual has lower levels of DA additional DA improves cognition, whereas additional DA can impair performance in individuals with a high baseline level of DA. Thus, an optimal attentional state is associated with moderate levels of both NE and DA.

Barriers to Experiencing and Maintaining an Optimal Attentional State

In healthy individuals, barriers to experiencing an optimal attentional state include many factors, such as too much arousal, stress, anxiety, too many environmental distractions, mental/physical fatigue, sleep disruption/sleep deprivation, being emotionally overwhelmed, and overuse of psychoactive substances that affect alertness such as caffeine and alcohol. Furthermore, these factors can also make it difficult to maintain an optimal attentional state for a sustained period of time (minutes to hours). These difficulties in experiencing and maintaining an optimal attentional state can result in decreased work productivity, increased distractibility, poor memory performance, reduced decision-making ability, reduced ability to sustain attention, poor behavioral control, and difficulty regulating one's emotions, ultimately decreasing one's quality of life.

Pathologic disruptions in maintaining an optimal attentional state are among the most commonly reported symptoms of all neurologic and psychiatric conditions. Severe difficulties in maintaining an optimal attentional state are common in many clinical disorders that include hemispatial neglect, attention deficit hyperactivity disorder, traumatic brain injury, post-traumatic stress disorder, age-related cognitive decline, depression, Down's syndrome, schizophrenia and disorders of sleep such as narcolepsy. These more severe impairments in the attentional state include, but are not limited to, dysregulated alertness, impairments in sustaining attention, problems with attentional control such as that accompany high distractibility, impairments in shifting attention, impairments in regulating one's emotional response, and impairments in executive attention such as inhibiting inappropriate responses. These disorders of attentional state can severely impair daily cognitive function, functional independence, vocational aptitude, and overall quality of life.

Previous Interventions Aimed at Improving One's Attentional State

One approach to fostering this focused and alert, yet controlled and flexible attentional state is the use of pharmacological interventions that target dopamine (DA) and norepinephrine (NE) neurotransmitter systems. Dopamine is a neurotransmitter intimately involved in alertness, reward, and motor control. Dopamine agonists such as bromocriptine, apomorphine, dextroamphetamine, amphetamine, and methylphenidate have shown to improve alertness, focus, and motor control. However, a number of reports suggest that the effects of dopamine agonists are not completely predictable and may even exacerbate attention difficulties in some individuals. Also, though dopamine agonists have shown to be successful in improving attention in some clinical conditions, such as increased focus in individuals with attention deficit hyperactivity disorder (ADHD), these pharmacological treatments may also produce unwanted systemic side effects such as nervousness, restlessness, difficulty falling asleep or staying asleep, and uncontrollable shaking of a part of the body.

Norepinephrine (NE) targeted pharamacological interventions have also been developed to enhance one's attentional state. Norepinephrine, primarily synthesized in the locus coeruleus (LC) and released throughout the cerebral cortex, is a neurotransmitter intimately involved in alertness, focus, and working memory. Noradrenergic agonists such as modafinil and guanfacine have shown to improve frontal lobe cognitive functions such as working memory, cognitive control, and the prevention of distraction by irrelevant stimuli. It has been shown that the influence of NE on the prefrontal cortex (PFC) has an inverted U-shaped function: either too little or too much NE impairs PFC functioning. NE's beneficial effects are typically shown at post-synaptic alpha 2A receptors. One example of NE's beneficial effects on attention is that guanfacine, an alpha 2A noradrenergic agonist, has shown to significantly improve self-ordered space exploration and motor symptoms in individuals with hemispatial neglect. However, guanfacine failed to improve performance on speeded visual search tasks in this clinical population. Guanfacine has also shown to be effective in improving ADHD symptoms, but may also produce unwanted systemic side effects (e.g., sympathetic nervous system over activation).

Behavioral training to promote a more optimal attentional state has shown to improve an individual's attentional state without introducing unwanted side effects such as those associated with pharmacological interventions. For example, increasing alertness in patients with hemispatial neglect either extrinsically, using unexpected and alarming auditory tones, or more intrinsically, where patients learn to cue themselves, has shown to improve several aspects of spatial and non-spatial attention deficits (see Robertson et al., 1998). Unfortunately, improvements using these methods have either been short-lived (external cueing effects typically last on the order of seconds to minutes) or have failed to produce lasting improvements in attention that generalize to daily life settings.

Another method, focused attention mediation, involves attending to one object or sensation for a prolonged period of time and requires sustained attention, the ability to disengage from distracting objects, and the ability to redirect focus promptly to the chosen object. After several weeks of focused attention meditation, researchers have found improved sustained attention abilities and increased attentional stability. However, meditation training may be difficult to perform without sufficient guidance and may be impractical to practice due to the intensive time requirements.

Attention Process Training program (APT) is a widely used cognitive rehabilitation program designed to primarily remediate attention deficits in individuals with brain injury and attention deficit hyperactivity disorder (Sohlberg and Mateer, 2001). It consists of a group of hierarchically organized tasks that exercise different components of attention commonly impaired after brain injury, including sustained, selective, alternating, and divided attention. The program places increasing demands on complex attentional control and working memory systems. The program also includes functional exercises (e.g., meal planning, vocational tasks) tailored to the individual. Clinicians can review available treatment packages and computer programs to ascertain what type of attention a particular patient requires. However this approach has many disadvantages, such as being complicated and time consuming, requiring a clinician to implement, and focuses more on a variety of tasks and skills rather than specifically focusing on modulating one's attentional state.

Another cognitive training program that has been developed to train attention is AixTent (see AixTent manual, Sturm et al., 2001). AixTent is similarly structured to attention process training with four subcomponents of training: alertness, selective attention, divided attention, and vigilance. The training exercises are constructed to present the attention training tasks in ecologically valid contexts represented in a computerized game format with difficulty adapted to each individual's performance/attentional capacity. Similar to attention process training, AixTent focuses on training several attention skills rather than specifically enhancing the individual's ability to maintain an optimal attentional state.

While the interventions discussed above are not without significant limitations, they clearly demonstrate that it is possible to enhance an individual's attentional state through either pharmacological or cognitive training methods. The current invention addresses the limitations of previous interventions and provides a novel technique for assessing and training an optimal attentional state and therefore cognition, via an interactive behavioral assessment and training system.

### SUMMARY OF THE INVENTION

The present invention provides a method for enhancing the attentional state of a participant. The method comprises at least one interactive behavioral training session which can be combined to form an interactive behavioral training regimen. The method involves presenting to a participant a continuous sequence of stimuli groups at a specific time duration. The stimuli groups comprise at least one target event or foil event and are presented to the participant at a specific time duration. The stimuli groups are separated in time by a variable inter-stimulus interval (ISI). The stimuli group may have more than one target event and/or foil event or mixtures thereof, and these may be separated in time by a variable inter-event interval (IVI) time. The interactive behavioral training session requires the participant to provide a response that involves an input from the participant when the participant senses the target event and/or foil events. The responses from the participant can be as follows: a) providing a first input upon sensing all foil events and withholding the first input upon sensing the target events; b) providing a first input upon sensing all foil events and providing a second input upon sensing a target event, wherein the first and second inputs are different; c) providing a first input upon sensing only target events and withholding the first input upon sensing a foil; or d) mixtures of a, b and c.

The method further comprises an assessment component that involves assessing the participant's attentional state prior to administering the interactive behavioral training regimen to ascertain the participant's pre-training attentional state index and/or assessing the participant's attentional state during the interactive behavioral training regimen to ascertain the participant's mid-training attentional state index. The assessment may be performed by a) a repeated behavorial assessment battery; b) the interactive behavioral training session of the invention; c) physiological and/or real-world assessments or mixtures thereof. These assessments can be used to adjust the interactive behavioral training session, and more particularly to alter the interactive behavioral training session task parameters. The task parameters include variable inter-stimulus interval (ISI), target frequency, presence/absence of distractors, similarity between target and foil and/or spatial location of presentation based on said determining.

The adjustment to the task parameters is performed using an adaptive based on the pre-training and/or mid-training attentional state index. The steps of the method can be repeated in an iterative manner to improve the attentional state of the participant.

The interactive behavorial training program is of sufficient intensity to create an enduring behavioral change in modulatory functions of attention and to achieve an enhanced attentional state in the participant.

The present invention also provides an interactive behavioral training session that involves presenting to a participant a continuous sequence of stimuli groups wherein the stimuli groups are separated in time by a variable inter-stimulus interval (ISI); and requiring the participant to provide a response comprising an input upon sensing the at least one target event or foil event. The session also involves assessing the participant's attentional state prior to administering the interactive behavioral training regimen to ascertain the participant's pre-training attentional state index. The session may also involve reassessing the participant's attentional state during the interactive behavioral training regimen and/or during the at least one interactive training session to obtain a mid-training attentional state index.

The interactive behavioral training session of the present invention may be adjusted based on the person's mid-attentional state index.

The assessment of the participant's pre- mid- or post-training attentional state involves measuring the reaction time variability, accuracy, reaction time, or decrement associated with the response or mixtures thereof. The results of the assessments are then used to altering one or more task parameters based on the participant's pre-, mid- or post training attentional state index.

The task parameters comprise stimulus discrimination, duration of stimulus presentation, complexity/difficulty of discrimination task, stimulus novelty, presence of spatial distracters of similar or dissimilar foils, target frequency versus foil frequency, and location or type of stimulus.

In certain embodiments, adjusting the interactive training session comprises altering the variable inter-stimulus interval (ISI), and/or altering additional task parameters.

The modulatory functions of attention include an alteration of norepinephrine and dopamine levels to a more balanced state; increased alertness, increased focus and freedom from distraction; increased behavorial control, greater short-term memory capacity, improved decision making ability, enhanced learning ability, increased capacity to regulate one's emotional responses, enhanced spatial attention and improved motor control.

The present invention also provides a method for diagnosing the presence or severity of an attention state dysfunction in a participant. The method involves assessing the participant, providing to the participant a behavioral interactive training session or regimen to the participant, and then reassessing the participant. The assessments are compared against each other to determine if the participant improved during the regimen. Also, the assessments can be compared against a predetermined benchmark. The results of these comparisons are then used to diagnose the presence or severity of an attention state dysfunction in the participant.

The current invention also provides an attentional state enhancement interactive behavioral training system comprising task parameters; the system comprising means for presenting to a participant a continuous sequence of stimuli groups at a specific duration separated by a variable inter-stimulus interval (ISI); wherein the sequence of stimuli groups contains both target stimuli and foil stimuli. The system also comprise means for receiving a response from the participant reacting to the stimuli; means for recording the participant's response, wherein the response comprises a response withholding response or a response switching response. The system may further comprise a means for assessing the participant's response; and a means for altering the task parameters based on the participant's response.

The present invention also provides a computer-implemented interactive behavioral training system comprising a central processing unit; a memory, coupled to the central processing unit. The memory stores a computer program mechanism, which comprises a data repository. The data repository provides varies modules: 1) a stimuli presenting module configured to provide a continuous sequence of stimuli groups at a specific duration for presentation to the subject; 2) a variable inter-stimulus interval (ISI) module configured to vary the interval between the presentation of the stimuli groups; and 3) a response time variability module configured to measure the variability in a participant's response time; and 4) a recording module configured to record participant responses; 5) optionally a module or modules configured to measure mean response time; to measure commission accuracy; to measure response time; to measure vigilance decrement; to measure accuracy for target or foil avoidance; to measure target accuracy amongst distracters and/or to measure omission accuracy; and 6) optionally a module or modules configured to alter a training session by altering one or more task parameters selected from the group consisting of altering stimulus discrimination; altering the stimulus; altering ISI duration; altering rule complexity; altering the variance of inter-stimulus interval; altering stimuli novelty; altering spatial distracters; altering similar or dis-similar foils and altering frequency of targets presented versus non-targets.

The further may comprising an assessment module for assessing participant responses and/or a module for altering the task parameters based on the assessment of the participant's responses.

The present invention also provides a computer accessible memory medium for carrying out an interactive behavioral training session to enhance the attentional state in a participant. The medium comprises program instructions utilizing a computing device to: a) provide a set of stimuli groups for presentation to the participant, wherein each stimulus group is presented for a specified duration, and wherein the stimulus group in the continuous sequence of stimulus groups are separated by a specified variability in inter-stimulus-interval (ISI); b) record a response from the participant for each stimulus group; c) assess the response from the participant; d) adjust the duration ISI variability based on the assessment in step c; e) optionally adjusting at least one additional interactive behavioral training session task parameters selected from the group consisting of target frequency, presence/absence of distractors, similarity between target and foil and/or spatial location of presentation based on said determining, wherein said adjusting the duration, target frequency, presence/absence of distractors, similarity between target and foil and/or spatial location of presentation is performed using an adaptive procedure; wherein the adjustment is based on the assessment in step c; and f) optionally repeating steps a-e one or more times in an iterative manner to improve the attentional state of the person; wherein the program instructions are executable by a processor.

The attentional state enhancement interactive behavioral training system may have the means for presenting to a person a continuous sequence of stimuli groups; the means for receiving a response from the participant; and the means for recording the participant's response are performed using a computer, a LAN, a WAN or the Internet.

The present invention also provides a method for implementing an interactive behavioral training session for enhancing a participant's attentional state by delivering computer readable instructions, the method comprising: a) transmitting, over a signal transmission medium, signals representative of a set of stimuli groups for presentation to the participant, wherein each stimulus group is presented for a specified duration, and wherein the stimulus group in the continuous sequence of stimulus groups are separated by a specified variability in inter-stimulus-interval (ISI); b) receiving, from a signal transmission medium, signals representative of the participant's response to the stimuli groups, and recording the responses to the stimuli groups; c) assessing the response from the participant and adjusting the duration ISI variability based on the response; and d) transmitting, over a signal transmission medium, signals representative of a set of stimuli groups for presentation to the participant, wherein the stimulus group in the continuous sequence of stimulus groups are separated by an altered specified variable inter-stimulus-interval (ISI) from c.

The present invention also provides a computer system for carrying out the method of enhancing the attentional state in a participant of the present invention. The computer system comprises one or more processors configured to execute program instructions; and a computer-readable medium containing executable instructions that, when executed by the one or more processors, cause the computer system to perform a method for enhancing the attentional state in the participant.

The present invention also provides a computer-implemented method for enhancing the attentional state of a participant. The method is described above and herein.

The present invention also provides a computer program product, comprising a tangible computer readable medium comprising executable instructions for effecting the following steps: a) presenting to a participant a continuous sequence of stimuli groups at a specific time duration, wherein the stimuli groups comprise at least one target event or foil event at a specific time duration, wherein the stimuli groups are separated in time by a variable inter-stimulus interval (ISI); and b) requiring the participant to provide a response comprising an input upon sensing the at least one target event or foil event; wherein the interactive behavorial training session is of sufficient intensity to create an enduring behavioral change in modulatory functions of attention and to achieve an enhanced attentional state in the participant; c) assessing the participant's attentional state prior to administering the interactive behavioral training regimen to ascertain the participant's pre-training attentional state index and/or assessing the participant's attentional state during the interactive behavioral training regimen to ascertain the participant's mid-training attentional state index; d) optionally adjusting the interactive behavioral training session task parameters, selected from the group consisting of the variable inter-stimulus interval (ISI), target frequency, presence/absence of distractors, similarity between target and foil and/or spatial location of presentation based on said determining, wherein said adjusting the duration, target frequency, presence/absence of distractors, similarity between target and foil and/or spatial location of presentation is performed using an adaptive procedure; wherein the adjustment to the task parameters is based on the pre-training and/or mid-training attentional state index; wherein the adjustment to the task parameters is based on the assessment in step c); and e) optionally repeating steps a-d one or more times in an iterative manner to improve the attentional state of the participant.

The present invention also provides a non-transitory computer readable storage medium storing a computer program product which, when executed by at least one processor, causes the processor to perform method of the present invention.

### BRIEF DESCRIPTION OF DRAWINGS

The present invention is illustrated by way of example, and not by way of limitation, in the figures of the accompanying drawings in which like reference numbers refer to like items.

FIG. 1 is a diagram from Yerkes & Dodson (1908) illustrating the alertness (arousal) vs. performance curve/relationship.

FIG. 2 illustrates a computer-controlled apparatus for collecting responses, neurophysiological and/or physiological feedback as well as administering interactive behavioral assessments and exercises for optimizing the attentional state.

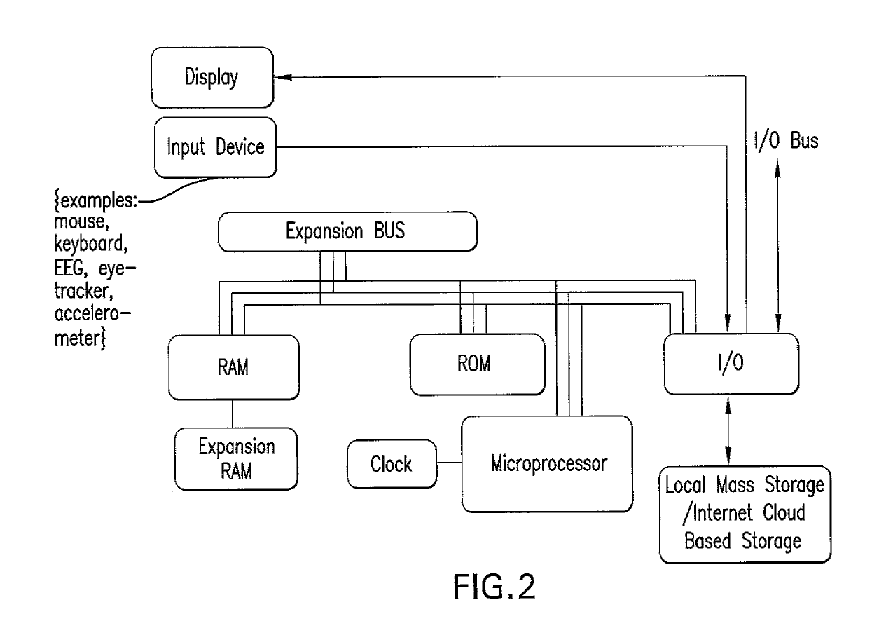

FIG. 3 is a diagram illustrating the course of engagement with the current invention.

FIG. 4 is a diagram illustrating the general delivery of the interactive behavioral training session.

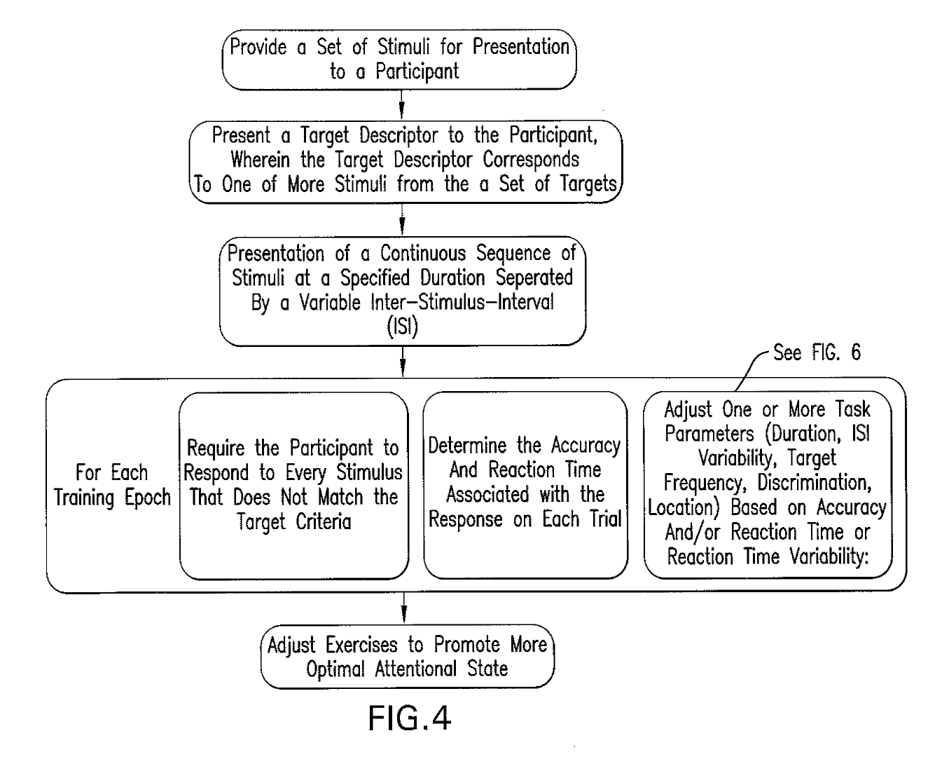

FIG. 5 is a diagram illustrating the cognitive domains assessed in the assessment battery and how performance on these tasks influence the task parameters of the interactive behavioral training session.

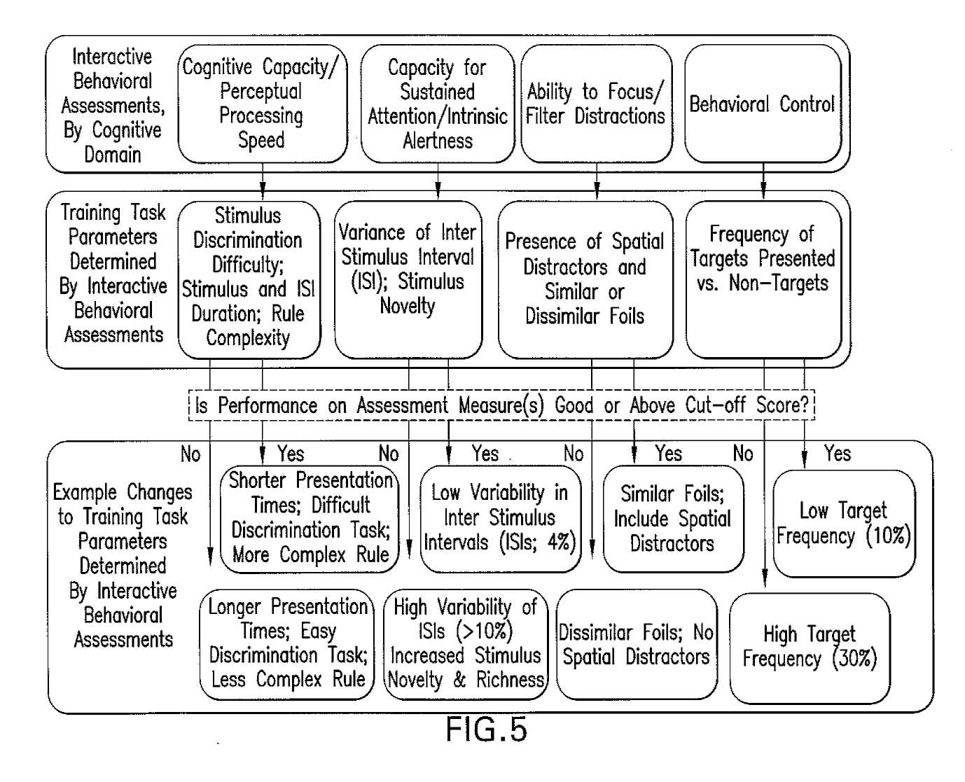

FIG. 6 is a diagram illustrating the cognitive domains assessed via performance on the interactive behavioral training task and how real-time performance on these domains can be used to make real-time modifications to the task parameters of the interactive behavioral training regimen.

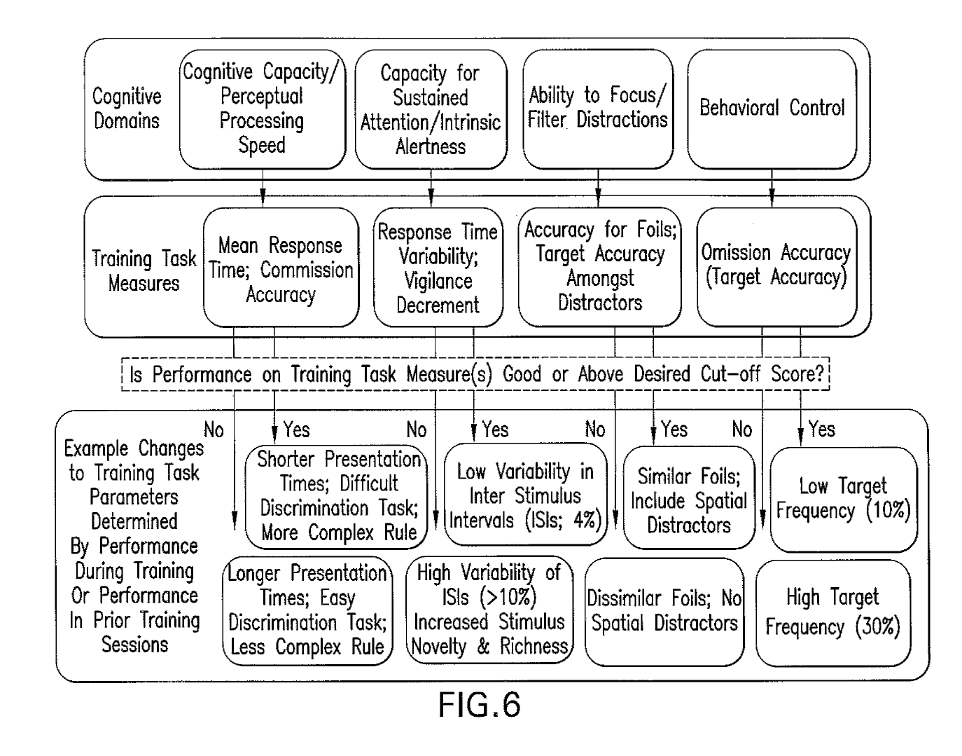

FIG. 7 shows a diagram and parameters of a version of the present invention tailored to treat patients suffering from hemispatial neglect discussed in the example 1.

FIG. 8 shows MRI and CT scans of patients involved in the study in example 1. These patients presented with a variety of right hemisphere etiologies/lesion types: one tumor resection, four traumatic brain injury, seven middle cerebral artery infarction.

FIG. 9 shows a Conjunction Search Task in which participants had to find the unique item shown randomly on the left or right side of screen (i.e., red square): the x-axis shows performance pre and post TAPAT; the y-axis shows the mean threshold presentation time (ms) necessary for 75% detection accuracy. See example 1.

FIG. 10 shows Landmark Task before and after TAPAT training. Participants were asked to judge the location of the midpoint of the black line. The x-axis indicates the deviation in pixels of the patient's subjective estimation from the objective center of the line. See example 1.

FIG. 11 shows the results of a spatially presented version of the attentional blink task in which rapidly presented characters containing 2 target numbers were presented at either the center or to the left or right of central visual fixation. The x-axis indicates the temporal position of the second target relative to the presentation of the first (lag 2=2 ordinal positions between target presentations) when shown on the critical, left side of the screen; the y-axis shows performance (second target accuracy) pre and post training on an auditory version of TAPAT. See example 2.

FIG. 12 shows the results of an attentional blink task in which rapidly presented characters containing 2 target numbers were presented at central fixation. The x-axis indicates when the critical, second target appeared on the screen relative to the first (lag 2=2 ordinal positions between target presentations); the y-axis shows performance (second target accuracy) pre and post an auditory version of TAPAT. See example 3.

### DETAILED DESCRIPTION OF THE INVENTION

In the following description, numerous specific details are set forth in order to provide a more thorough understanding of the present invention. It will be apparent, to one skilled in the art, however, that the present invention may be practiced without some or all of the specific details. In other instances, well known process steps and/or structures have not been described in detail so as not to unnecessarily obscure the present invention.

General Philosophy of the Inventive Technique

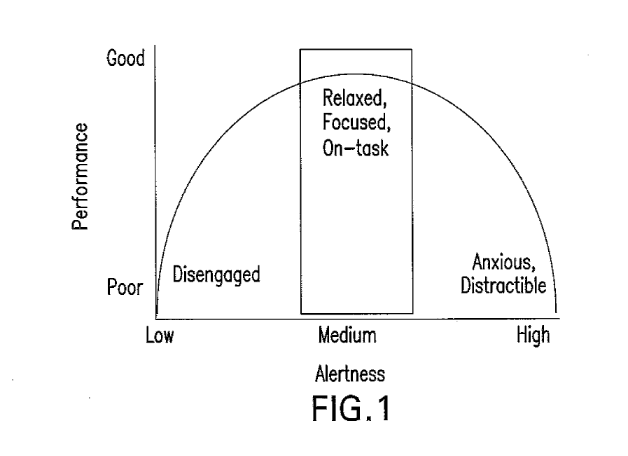

The nature of the present invention is that it promotes a more optimal attentional state that enables high levels of cognitive performance. It does this by promoting a sustained attentional state of relaxed, alert readiness. In this state, which can be thought of as the middle part of the Yerkes-Dodson inverted U-shaped curve (see FIG. 1), the participant can sustain cognitive efforts with greater ease and less effort and fatigue. In addition, this state is characterized by improved focus on the task at hand and less susceptibility to external distractions. This state is also characterized by behavioral flexibility and control, such as the ability to effectively shift attention and the ability to inhibit a pre-planned action. It may also be characterized by more control over one's thoughts and emotions. Additionally, this balanced, focused attentional state is also characterized by an enhanced ability to encode and retrieve information from memory. Lastly, this state is also characterized by an enhanced learning ability.

The present invention provides an interactive behavioral training regimen, which is used to enhance a participant's attentional state through the implementation of three key and novel combination of elements in the interactive behavioral training session: 1) requiring the participant to constantly monitor stimuli over a prolonged duration, thus exercising and improving the capacity to sustain an optimal level of alertness (i.e. enhancing attentional state); 2) requiring the participant to frequently respond throughout the interactive training session to fully engage the participant, which also serves to allow constant monitoring of the individual's attentional state and to frequently adapt the task parameters in the training session to better enhance the individual's attentional state; and 3) a response inhibition or response switching component in the interactive behavior training that fosters a controlled and flexible state of engagement.

### Constant Monitoring of Stimuli

The first element of the interactive behavioral training session involves constant monitoring of stimuli (i.e., determining which stimuli are target events and which are foil events (non-targets), which may require different behavioral responses) over a prolonged period of time. Target event vs. foil event decisions may be based on a pre-learned stimulus (e.g., requiring subjects to memorize a target event scene before the task starts), pre-determined categories (e.g., requiring subjects to memorize a target event category such as “shoes” before the training session starts), or simple and complex rules that do not require a memory component (e.g., requiring the participant to identify a target event stimulus as any stimulus that is repeated twice in a series of sequentially presented stimuli). The present invention entails the use of timing variability between stimulus groups—the stimulus groups presented to the participant are separated in time by a variable inter-stimulus interval (ISI). This is implemented to engender greater response control and better keep the participant engaged and on-task (Ryan et al., 2010). For example, in one embodiment, participants with more difficulty staying on task could have their training session altered to have a more jittered/unpredictable inter-stimulus-intervals (ISI) between stimuli (for example a 10% temporal jitter) wherein the unpredictability in the temporal presentation rate facilitates greater task engagement and response monitoring. In another embodiment, participants with an easier time staying on task could have their training session altered to have a more consistent ISIs between stimuli (for example, a 4% temporal jitter). The temporal occurrence of targets and non-target stimuli will typically be unpredictable, but may be predictable under certain circumstances. Depending on the paraticipant's perceptual and intellectual abilities, the stimuli may be presented for short (50 ms) or long durations (500 ms) and may be presented as an abrupt stimulus onset or gradually fade between stimuli from one trial to the next at various ISIs.

### Elicitation of Motor Response

The second element of the current invention requires the participant to frequently elicit a motor response (an input) to stimuli, in many cases 20-100 times per minute. This serves to constantly engage the participant in the task, and can have a stimulating effect, especially in hypo-aroused populations (e.g., patients suffering from hemispatial neglect). Responses may be required at somewhat regular intervals according to the participant's speed of processing capacity, motor abilities, and their ability to stay on task. For example, for subjects with exceptional processing speed, motor abilities, and focus, the training task could require a significantly higher rate of responding than for subjects with diminished processing speed, motor abilities, and focus. Participants typically respond to the majority of stimuli presented (anywhere from 55% to 97% of stimuli) and inhibit or shift their response to an alternate behavior for the minority of stimuli (anywhere from 45% to 3% of stimuli).

Requiring a frequent response from the participant, facilitates greater, real-time monitoring of the participant's attentional state throughout the training task, and allows for real-time adjustments to the task parameters in the training session to better foster an optimal attentional state. For example, increased response time variability indicates that a participant is getting off task and could result in the training session being modified (e.g., increasing the temporal variation of inter-stimulus intervals) to better keep the participant on task.

### Promotion of Behavioral Control and Flexibility

The third element of the current invention promotes behavioral control and flexibility by requiring participants to periodically inhibit their responding (withholding an input)(“response withholding”) or switch to another type of response (using a different type of input)(“response switching”). This element is crucial in fostering response control and self-monitoring during the training session. For example, in one embodiment, during some training sessions, the participant is required to withhold or switch his response when presented with specified stimuli (e.g., the presentation of a target event image), he will be more careful about evaluating all stimuli and more careful when initiating a motor response. Thus, this provides the participant with the tools to be able to break an undesired behavior that occurs after a reflexive or repetitive stimulus. In a certain embodiment, the demands on response monitoring is varied in order to maximize control and flexibility in the particular individual (e.g. successfully being able to choose between responding and withholding/shifting a response, not simply responding in a reflexive manner). Demands on response monitoring means changing the frequency of target presentation versus foils (non-targets). If the participant is responding on 90% of stimuli (nontargets), it is difficult to withhold the response to targets when they appear so infrequently (in this case 10%) For example, for subjects in need of greater response control (e.g., individuals with ADHD), one embodiment comprises a higher percentage of trials requiring inhibitions or switches to promote a more controlled state of engagement. Further, in another embodiment, subjects who have higher levels of response control could be presented with a lower percentage of trials that require inhibitions or switches (e.g., 90% or more), which may make inhibiting one's response particularly challenging and promote better intrinsic regulation of one's response control.

Accordingly, the present invention provides a method for enhancing the attentional state of a participant utilizing a novel interactive behavioral training regimen. The participant can be any mammal or animal, including humans. The interactive behavior training regimen of the present invention comprises at least one interactive behavioral training session. The interactive behavior training sessions are provided to the participant in an iterative manner as necessary to improve the attentional state of the participant. As a non limiting example, a participant's interactive behavior training regimen may comprise the administration of five interactive behavior training sessions for two days, followed by the administration of one interactive behavior training sessions each day for a total of two weeks. The length of the interactive behavioral training sessions can vary as necessary, ranging for example (but not limited to) roughly five minutes to about an hour.

“Enhancing the attentional state” means to improve the participant's attentional state. The improvement may be short term (e.g. during the interactive behavioral training session or the interactive behavioral training regimen or immediately after) but preferably provides long lasting improvement in the particpant's attentional state or in the ability to enter into an improved attentional state when desired or needed (e.g. real world applications after the completion of the training regimen). In otherwise “normal” individuals, the methods of the present invention can be used to improve the attentional state to bring it up to the optimal or even the superior range. An optimal attentional state has the following characteristics: 1) a moderate level of alertness; 2) focus and freedom from distraction; and 3) behavioral control and flexibility. When an individual has attained an optimal attentional state, the individual reaps other benefits such as an improved cognitive functioning.

“Enhancing the attentional state” also may include improving or enhancing cognition, which can manifest itself in many mental processes, such as, but not limited to, an alteration of norepinephrine and dopamine levels to a more balanced state; increased alterness, increased focus and freedom from distraction; increased behavorial control, greater short-term memory capacity, improved decision making ability, enhanced learning ability, increased capacity to regulate one's emotional responses, enhanced spatial attention and improved motor control, memory retention, the ability to learn in a faster and more efficient manner, optimized function in modulatory neurotransmitters including serotonin, norepinephrine, dopamine and acetylcholine; improved ability to respond to stimuli without a significant decrease in performance over time; appropriate release of modulatory neurotransmitters associated with at least one of remediating attentional state and the clinical symptoms of poor attentional state; achieving a more calm state; a greater regulation of the sleep/waking cycle.

Methods of the present invention can be used with participants having attentional state dysfunction. Methods of the present invention can be used to improve their levels and in some cases bring them up to normal levels.

The current invention incorporates elements in the interactive behavioral training sessions and regimen that foster the ability of the participant to stay on task for a prolonged period of time (elements such as, but not limited to, stimulus novelty, variable inter-stimulus intervals, and response inhibition demands), and thus, helps the participant attain a more optimal attentional state, which in turn improves cognition. As a participant improves his attention state via the interactive behavior training session of the present invention, he will be able to stay in an optimal attentional state for longer periods of time, at which point task parameters in the interactive behavior training session that helped the participant stay on task may be gradually removed to foster the ability of the participant to stay on task using more intrinsic mechanisms. In other words, behaviors learned during the interactive behavioral training regimen can be later employed by the participant in real-world situations. Assessing and training this focused and flexible attentional state in the current system over many sessions helps generalization of the optimal attentional state to one's day-to-day activities.

Methods of the present invention provide techniques for assessing and enhancing normal attention functioning, which provides the ability for the participant to operate in the superior range. Methods of the current invention enable faster and greater skill acquisition via engendering a more optimal mode of engagement with one's thoughts, emotions and relevant stimuli from the external environment.

Methods of the present invention further provide techniques for assessing, diagnosing, and remediating dysfunctions of attention in neurologic and psychiatric populations that may present with dysregulated arousal, impairments in sustaining attention, problems with attentional control such as that accompany high distractibility, impairments in shifting attention, and also impairments in executive attention such as inhibiting inappropriate responses. The interactive behavioral training session and regimen is designed to remediate this class of attentional dysfunction by stabilizing the moment-to-moment and daily regulation of an optimal attentional state. This class of attentional dysfunction may manifest in populations such as those suffering from hemispatial neglect, attention deficit hyperactivity disorder, traumatic brain injury, post-traumatic stress disorder, age-related cognitive decline, depression, Down's syndrome, schizophrenia and disorders of sleep such as narcolepsy.

The interactive behavioral training session and regimen of the present invention entails both a behavioral training component and an assessment component that are interdependent. The training component is the source of the therapeutic effect, while the assessment component helps determine the initial and ongoing task parameters for the training component, helping to optimize the training component to promote long-lasting behavioral changes. Additionally, initial assessments provide a baseline for comparing subsequent training-related performance gains, monitoring a participant's improvement over the course of training, tracking their progress relative to the continuum of normal performance, and determining whether or not more training is recommended.

Using methods of the present invention, the attentional state of a participant is enhanced using the interactive behavioral training regimen of the present invention. The interactive behavioral training regimen comprises at least one interactive behavioral training session and in certain embodiments comprises more than one interactive behavioral training session. The interactive behavioral training session comprises task parameters, discussed herein below. The interactive behavioral training session involves presenting to a participant a continuous sequence of stimuli groups at a specific time duration. The stimuli group has at least one target event or foil event and can have more than one target and/or foil event. The interactive behavioral training session comprises at least one and preferably more than one stimuli groups.

A target event is an event to which the participant has been instructed to respond. A foil event is any other event that is not a target event. The mode in which the stimuli comprising target and/or foil events are delivered to the participant may vary and may include, but is not limited to, an auditory mode, where the stimuli are presented audibly; a pictorial mode, where the stimuli are presented pictorially; an orthographic mode, where the stimuli are presented textually; a haptic mode, where the stimuli are presented tactilely; or a cross-modal mode, wherein the stimuli are presented as a combination of any two or more modalities. Stimuli may be from multiple sensory modalities presented simultaneously. For example, one stimulus group may present the events audibly and the next stimulus group may present the events pictorially.

The stimuli can be any item that can be sensed with the five senses. For example, the stimuli and thus, target and foil event can be a single object, a scene, a category, or can be described as having an attribute or one or more attributes, a rule; or a correspondence condition. For example, the participant can be instructed that the target event is a tree and the foil events are other objects that do not include any type of tree. In another example, the target could be an evergreen tree and the foils could include deciduous trees. In another example, the target could be described as having attributes. For example, pictures of objects having the attribute that they can be eaten are defined as a target event, whereas pictures of anything that is not edible is defined as a foil event. The target could also comprise a plurality of attributes, comprising two or more attributes (e.g. example, color; shape; texture; quantity; pitch; frequency; meter; pressure; spatial location; absence of a specified color; absence of a specified shape; absence of a specified texture; absence of a specified quantity; absence of a specified pitch; absence of a specified frequency; absence of a specified meter; absence of a specified pressure; or absence of a specified spatial location).

In some embodiments, the stimulus group comprises a plurality of stimuli. For example, the target event is defined in the situation where a plurality of stimuli share one or more relationships of attributes. Examples include, but are not limited to: identical (where each stimulus of the plurality of stimuli, has an identical attribute value); common (where each stimulus of the plurality of stimuli, has a common attribute value); or distinct (where each stimulus of the plurality of stimuli, has a different attribute value). For example, the participant is instructed that the target event occurs when one or more stimuli presented are identical, share a common attribute or have distinct attributes. An example of the “identical” is as follows. The stimuli are presented as different objects appearing on the screen. When the screen shows two objects appear that are identical, then the target event has occurred. When the screen shows objects that are not identical, a foil event has occurred. An example of “common” is as follows. The stimuli are presented as different objects appearing on the screen. When the screen shows two objects that share a common attribute (e.g. the two objects are two different birds) a target event has occurred, whereas when the screen shows objects not sharing a common attribute such as a blue car and a green tree, then a foil event has occurred. An example of “distinct” is as follows. The stimuli are presented as different objects appearing on a screen. When the screen shows three objects all cats, then a foil event has occurred, whereas when the screen shows three objects, one a cat, one a house and one a dog, then a target event has occurred.

The attributes of the stimuli can be, but are not limited to, two or more of color; shape; texture; quantity; pitch; frequency; meter; pressure; spatial location; absence of a specified color; absence of a specified shape; absence of a specified texture; absence of a specified quantity; absence of a specified pitch; absence of a specified frequency; absence of a specified meter; absence of a specified pressure; or absence of a specified spatial location.

The stimulus groups are presented to the participant and are separated in time by a variable inter-stimulus interval (ISI). In other words, the time between the presentation of each stimulus group varies. For example, the time between the first and second stimulus group is 1.5 second but the time between the second and third stimulus group is 1 second, and the time between the third and fourth stimulus group is 2 seconds, etc. The variability is rendered so it is unpredictable.

Sometimes a stimulus group is one stimuli, whether a target or a foil. In some instances, where the complexity is increased, a stimulus group may have more than one stimuli. This is necessary when the target event has been defined as two stimuli having common or identical attributes, as mentioned above. Or it may be desirable to present more than one stimuli in each group. For example, to promote intrinsic focus and practicing filtering out distracting information, peripheral distractor stimuli may be presented at the same time as the central task-relevant stimuli. When the stimulus group is more than one stimulus, the presentation of the more than one stimulus may be separated in time a variable inter-event interval (IVI). For example, the stimuli may be presented all at once at the exact same time, or for example, three of the stimuli may be presented at the exact same time, but then the forth stimuli shows up on the screen delayed by 0.002 second delay or then the fifth stimuli in the group shows up on the screen delayed by a 0.001 second delay, etc.

In the interactive behavioral training session of the present invention, the participant is required to provide a response upon sensing the target event or foil event. The response requires an input or lack of input from the participant. For example, the response may be clicking the mouse, hitting the space bar, or touching a screen. In other examples, the response may involve other bodily movements, such as, but not limited to, raising a hand, tapping a finger, blinking an eye, nodding of the head, movement of the eye, movement of the tongue, making a noise, saying a word, etc.

The participant is preferably instructed to provide an input upon sensing all foil events and is instructed to withhold the input upon sensing a target event (e.g. clicking the mouse each and every time upon sensing a foil event but not clicking the mouse when sensing a target event). This behavior is referred to herein as “response inhibition.” In other embodiments, the participant is instructed to provide a first input upon sensing all foil events and is instructed to withhold the first input and provide a different input upon sensing a target event (e.g. clicking the mouse each and every time a foil event is sensed, but when a target event is sensed, not clicking the mouse but instead touching the screen). This behavior is referred to herein as “response switching.” In another embodiment, the participant is instructed to provide an input upon sensing only target events and withholding (not doing any input) upon sensing the foil events. This is referred to as “target preference response.” In some embodiments, during an interactive training session or during the interactive training regimen the participant may be instructed to provide one or more different types of behaviors or a mixture of the three behaviors described above. For example, during the first training session of the day, the participant is instructed to follow the response inhibition rule, but during the second training session of the day, the participant is instructed to follow the response switching rule.

In some embodiments, the responses/inputs by the participant are recorded by a recording device (e.g. computer registers the clicking of the mouse). In addition to recording the responses/input or lack of inputs, whether the participant responded correctly, and how quickly the participant responded is also recorded in certain embodiments. In certain embodiments, the participant is required to respond before the next stimulus group is presented and failure to do so is considered an error or a wrong response. Other parameters recorded and assessed include mean response time; commission accuracy; response time; vigilance decrement; accuracy for target or foil avoidance; target accuracy amongst distracters and/or omission accuracy.

The participant's response to the stimulus group that may be recorded and assessed can be, but is not limited to: 1) a correct response (e.g. a correct omission—where the participant correctly indicates by withholding the response upon sensing the target event; or a correct commission—where the participant correctly indicates when at least one stimulus in the stimulus group does not correspond to the target event); 2) an incorrect response (commission error—where the participant responds to the target event; or an omission error—where the participant incorrectly withholds the response to a foil event).

The interactive behavior system of the present invention can also provide a feedback upon recording the response. For example, the participant may receive feedback when an error was made or when a correct response was made. For example, the feedback may be in the form of a reward (e.g. a pleasing noise, picture, or sensation, etc.) or in the form of a punishment (e.g. an unpleasant noise, unpleasant picture or sensation, etc.). Performance feedback is used to motivate participants and inform them of their progress in improving their attentional state. This could include stimulus group feedback during the training session, feedback at the end of each training session, as well as feedback on the behavioral assessments.

The interactive behavior training regimen and its sessions of the present invention are of sufficient intensity to create an enduring behavioral change in modulatory functions of attention and to achieve an enhanced attentional state in the participant. Intensity can include, for example, the number of sessions administered, the length of the sessions, the difficulty of the sessions, the variability within the sessions and within the regimen, and the length of the overall interactive behavior training regimen, etc.

As discussed below, the current invention also comprises a system of behavioral assessments. Assessment is crucial for determining the nature/complexity of the task parameters of the interactive behavior training session across a broad range of individuals, from profoundly impaired to those with superior cognitive performance, adapting the task parameters to each individual within and across interactive behavior training sessions, and measuring the effectiveness of the interactive behavior training session. As noted below, the present invention utilizes known assessment approaches, such as a repeated behavioral assessment battery and physiological and/or real-world assessments, as well as, utilizes the training sessions of the present invention to assess the participant.

In certain embodiments, the interactive behavioral training regimen comprises assessing the participant's attentional state prior to administering the interactive behavioral training regimen to ascertain the participant's pre-training attentional state index. The attentional state index is a measurement of the participant's attentional state and it can be compared to certain benchmarks or other known indices to ascertain the level of attentional state achieved by the participant. For example, normal individuals will perform on the assessments in a certain relative predictable level whereas individuals having an attentional state dysfunction will perform at a lower level.

This pre-training assessment can be performed by methods known in the art, including a repeated behavioral assessment battery (discussed in more detail below); or physiological and/or real-world assessments (discussed in more detail below), subjecting the participant to at least one interactive behavioral training session of the present invention, or a mixtures thereof

The repeated behavioral assessment battery provides both a baseline for the participant to compare to subsequent training sessions and is also used to determine the initial task parameters of the initial training session (e.g., duration, ISI, level of discrimination difficulty). This repeated behavioral assessment battery includes well-validated, sensitive, reliable tests with minimal practice effects (alternate test forms may be used when practice effects are prevalent, such as for tests of long-term memory) and good psychometric properties such as the absence of ceiling and/or floor effects. Certain elements of the battery may be tailored to specific populations (e.g., certain versions of sustained attention tasks such as Connors CPT are traditionally used to evaluate ADHD). However, all participants are assessed on the same domains of cognition, which include general cognitive capacity, perceptual processing speed, sustained attention capacity/intrinsic alertness, ability to focus/filter distractions, and behavioral control.

These assessments may be used to determine the initial task parameters of the initial interactive behavior training session. In particular, general cognitive capacity and perceptual processing speed are used to determine the presentation time of stimuli, the difficulty of the perceptual discrimination task, and the complexity of the target/non-target rule (e.g., easy rule: withhold a response when you see this target ‘shoes’; difficult rule: withhold a response when the picture presented is the same as the one two images back). Sustained attention capacity/intrinsic alertness is used to determine the variability of the inter-stimulus intervals and the novelty and richness of the stimuli presented. The participant's ability to focus/filter distractions is used to choose more or less similar foil stimuli or to include spatial distractors in the stimulus groups. Additionally, the participant's capacity for behavioral control may be used to determine the target event frequency in the training session. In addition to these tests, other cognitive assessments that may be enhanced via a more optimal attentional state are included—such as assessments of decision-making, memory (working memory and long-term memory), executive functioning, learning ability, and motor control. These repeated assessments may also include assessments of everyday aspects of attention such as work productivity, functional independence (for more impaired populations), forgetfulness, distractibility, and mood. In certain embodiments, this repeated battery of assessments is given periodically to check the participant's progress in the interactive behavior training session and to recommend further training sessions if the individual has not reached a pre-defined benchmark or goal (e.g., superior sustained attention performance) or, for disordered populations that have not reached the normal range of behavior.

In addition to the repeatable behavioral assessments, physiological measures (e.g., pupil dilation, breath rate, heart rate variability), neurophysiological measures (e.g., EEG/ERPs), and neuroimaging measures (e.g., fMRI) can be used to assess the effects of training and also adapt the task parameters in the interactive behavior training session to sufficiently challenge each participant. For example, in one embodiment, participants with a higher baseline pupil dilation and a smaller pupillary response to target stimuli, which has been shown to be associated with the sub-optimal explorative mode of attention, could be provided with a version of the task parameters that fosters more consistent engagement (e.g., more temporally jittered inter-stimulus intervals to protect against automated responding) and more response control (e.g., higher percentage of trials that require an inhibition of response) than participant's with smaller baseline pupil dilation and larger pupillary responses to targets (which is associated with the more optimal exploitative mode of attention). These physiological measures could also be implemented while performing the training session to enable real-time adjustments to the task parameters to better train the participant to be in a more optimal attentional state.

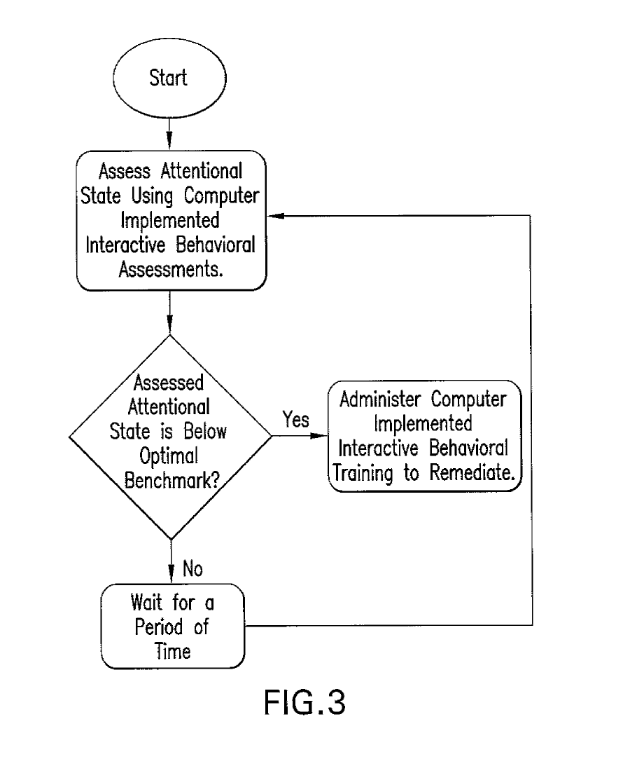

In addition to a repeated battery of assessments and physiological measures, performance on the interactive behavioral training session itself is used to adjust task parameters of the training within a session (intra-session) and between sessions (intra-regimen)(see FIG. 3). This allows adaption of the interactive behavior training session to a participant in real-time, based on his current attentional state, keeping him constantly challenged and better fostering the maintenance of a more optimal attentional state. In one embodiment, real-time adaptability is adjusted based on participant's performance for the various stimulus groups (e.g., accuracy, average response time, response time variability) as assessed approximately every 2-5 minutes, such as altering the number of trials/min, percentage of target events among foil events, and difficulty of target vs. foil discrimination. For example, in one embodiment, if during this 2-5 minute period the participant significantly changes his overall reaction time or commission accuracy this could lead to changes in presentation times and/or difficulty of the discrimination task (see FIG. 3). Additionally, if during this period the participant significantly changes his reaction time variability this could lead to changes in the variability of the inter-stimulus intervals and change in the novelty and richness of stimuli (see FIG. 3). Additionally, if during this period the participant significantly changes his accuracy for foil events or accuracy during the presence of distracters, this could lead to changes in the similarity of foils and the number of distractors (see FIG. 3). Also, if during this period the participant significantly changes his omission accuracy this could lead to changes in the percentage of target event (see FIG. 3).

In certain embodiments, the interactive behavioral training regimen also entails reassessing the participant's attentional state during the interactive behavioral training regimen and/or during the interactive behavior training session to obtain the participant's mid-training attentional state index.

In certain embodiments, the interactive behavioral training regimen and/or the interactive behavioral training sessions are adjusted or altered based on the person's mid-attentional state index. That is, the interactive behavioral training regimen or the interactive behavioral training sessions are not static but instead are dynamic, and thus are altered based on the results of the assessments (i.e. performance of the participant). This assessment and alteration can be set up as feedback look—simultaneously during the training sessions, the participant's performance is monitored and the remaining portion of the training session is adjusted accordingly (i.e. the assessment is also being conducted as the participant is performing the interactive behavioral training session). The results of the assessment dictate the manner or degree in which the training session should be altered. The feedback loop of assessment and adjustment can be performed intra-session (during the training session and having the training session adjusted during the session) or intra-regimen (after a training session is completed the next training session in the regimen is adjusted based on the assessment that occurred during or after the previous training session). More than one assessment and corresponding adjustment can occur, hence “the feedback loop.” The feedback loop could also occur both intra-session and intra-regimen.

In certain embodiments, the interactive behavioral training regime further comprises reassessing the participant's attentional state after the completion of the interactive behavioral training regimen and/or after the at least one interactive training session to obtain a post-training attentional state index or post-regimen attentional state index for the participant.

In certain embodiments all three assessments are performed (pre-, mid and post). Further, multiple assessments can be performed, as well as multiple adjustments to the interactive training session and/or regimen.

Participants are assessed using a battery of interactive exercises, the results of which are used to quantify the cognitive capacity/processing speed, capacity for sustained attention/intrinsic alertness, ability to focus and filter distractions, and behavioral control (see FIG. 3). The exact interactive behavioral assessments to measure attention will vary based on the healthy individual's needs or the type of attentional impairment of each clinical population.

Benchmarks for performing each interactive behavioral assessment may be defined by, for example, one's score on a questionnaire, accuracy, learning rate, d-prime, reaction time, reaction time variability, accuracy decrement over time, d-prime decrement over time, reaction time variability increase over time, and reaction time decrement over time.

In certain embodiments, a computer-implemented interactive assessment that measures perceptual processing speed and working memory such as the attentional blink is employed. For example, participants are shown a rapid stream of several letters in the center of the screen with one or two embedded target numbers positioned close together in time. This test measures the participant's ability to identify the target numbers at different positions in time apart. The results of the test may be used to determine the presentation time of the stimuli in the interactive behavioral training session.

In another embodiment, an assessment that measures the participant's ability to sustain attention such as a continuous performance test is employed. For example, the participant is shown a stream of images over a period of minutes and is required to respond as fast as he can to all images except that he is instructed to withhold his response when shown the target image. An alternative embodiment of this test is to have the participant respond to the target image and withhold the response to all non-target images. Because of its repetitive nature and the individual's proneness to disengage during this test, this provides a measure of the ability to sustain attention and prevent attentional lapses. The results of this assessment may be used to determine the temporal jitter of inter-stimulus intervals for the interactive behavioral training session.

In another embodiment, an assessment that measures the ability to resist distraction from irrelevant stimuli is employed. For example, participants are instructed to search for a target circle among an array of triangles and report whether a right-angled or left-angled line segment appears inside the circle. Participants could perform this task when all the elements are the same color (e.g. green) or during the presence of a distracting element (e.g. red triangle among green triangles and green circle). The dependent variable is how much this distracting element impairs the participant's ability to report whether a right-angled or left-angled line segment appears inside the circle. The results of this assessment may be used to determine how well the individual can filter out irrelevant distractions and, for the interactive behavioral training task, whether to include simultaneous spatial distractors.

In another embodiment, an assessment that measures the partcipant's ability to effectively inhibit the response such as in a go/no-go task is utilized. Go/no-go tasks require the participant to press a button when one stimulus type appears and withhold a response when another stimulus type appears. For example, the participant may have to press the button when a blue light appears and withhold when a yellow light appears. The results of this assessment may be used to determine the individual's behavioral response control as well as to determine the target vs. non-target ratio for the interactive behavioral training session.

In one embodiment, an assessment that measures object-based attention such as in the landmark task is employed. The participant may be given numerous trials in which he has to decide if a red mark on a long horizontal line is to the left or right of the center of the long line. This gives an indication if the participant has a systematic bias to attend more to one side of the line than the other. This test has been shown to be related to alertness (less alertness=more rightward bias) and the integrity of right hemisphere fronto-parietal networks. Typically, patients with leftward neglect and ADHD show a systematic bias to judge the center of the line to the right whereas healthy controls typically judge the center of the line veridically or slightly to the left of center.

In another embodiment, an assessment that measures visual search is employed. For example, the conjunction search task requires searching for a target object amongst an array of distractors that share a feature with the target object, such as searching for a red square amongst an array of blue squares and red triangles. The accuracy of target detection or display time for a specified percent (such as but not limited to 75%) target detection is measured. This test provides a measure of how efficiently visual attention is allocated across space and patients suffering from hemispatial neglect typically perform worse at finding leftward targets compared to rightward targets.

In another embodiment, a questionnaire or diary assessing everyday abilities to focus attention and daily incidence of cognitive failures is employed. This includes having the participant report the number of different types of attentional lapses he has throughout the day (e.g. failing to remember someone's name when meeting them or failing to notice signposts on the road) and his ability to focus on tasks at work. These questionnaires may be filled out once or on a daily basis for several days to determine how these measures fluctuate over a longer period of time.

In addition to the assessments described above, many other different factors can be measured during the participant's pre- mid- or post-training/regimen attentional state assessment. In certain embodiments, the factors measured include the reaction time variability, accuracy, reaction time, or decrement associated with the response, or mixtures thereof.

Adjusting the interactive behavioral training regimen or interactive behavioral training session involves altering one or more task parameters, and, as noted above, these alterations are based on the participant's pre-, mid-or post training attentional state index. Task parameters include stimulus discrimination difficulty, duration of stimulus presentation, complexity/difficulty of discrimination task, complexity/difficulty of the response rule (e.g. respond to any stimulus repeated 2 positions back vs. 1 position back), stimulus novelty, presence of spatial distracters of similar or dissimilar foils, target frequency versus foil frequency, location or type of stimulus, correspondence frequency (ratio of target events to foil events), and target/foil confusability (the degree to which stimuli corresponding to the target event are similar to stimuli that do not correspond to the target event) In a preferred embodiment the adjusting involves at least altering the variable inter-stimulus interval (ISI), and can include altering additional task parameters.

Altering or adjusting the task parameters includes increasing or decreasing the complexity of the individual task parameter or all of the task parameters. For example, one task parameter could be increased in complexity where another task parameter could be decreased in complexity. It also includes increasing or decreasing the entirety of the task parameters (e.g. making all task parameters more complex). In certain embodiments the adjustment of the task parameters is based on the value of the task parameters from the previous session, or based on an average of task parameters from all previous sessions. In certain embodiments, the task parameters are adjusted so that the participant is capable of responding with less variable response speed and is capable of responding more accurately to withhold response to target events. When this happens, the participant is training to be in a more optional attentional state.

Complexity can varied depending on the task parameter. For example when referring to timing variability, decreasing the variance in the time between stimulus groups would increase the complexity. As another example, increasing the similarities between the target events and foil events would increase the complexity.

In certain embodiments, the adjustments are performed in accordance with a maximum likelihood procedure, an analytic maximization procedure employed to drive peak performance on one or more training variables (e.g., target accuracy). In certain embodiments, the maximum likelihood procedure comprises a continuous performance maximum likelihood procedure such as, but not limited to QUEST (quick estimation by sequential testing) threshold procedure; or a continuous performance ZEST (zippy estimation by sequential testing) threshold procedure. These procedures make periodic changes to specified training variables (e.g., stimulus duration, ISI variability, target frequency) to fit a specified probability of success on one or more outcomes (e.g., target accuracy, response time variability).

In certain embodiments, the task parameters are adjusted so that a specified success rate for the participant is possible and maintainable. In certain embodiments the adjustments are configured using a single-stair continuous performance maximum likelihood procedure. This procedure can be carried out on a trial by trial basis via minor or major changes to specified variables (e.g., stimulus duration) in accordance with user performance.

Using methods of the present invention an interactive behavioral training regimen creates an enduring behavioral change in modulatory functions of attention and to achieve an enhanced attentional state in the participant. Modulatory functions of attention include but are not limited to an alteration of norepinephrine and dopamine levels to a more balanced state; increased alterness, increased focus and freedom from distraction; increased behavorial control, greater short-term memory capacity, improved decision making ability, enhanced learning ability, increased capacity to regulate one's emotional responses, enhanced spatial attention and improved motor control, memory retention, the ability to learn in a faster and more efficient manner, optimized function in modulatory neurotransmitters including serotonin, norepinephrine, dopamine and acetylcholine; improved ability to respond to stimuli without a significant decrease in performance over time; appropriate release of modulatory neurotransmitters associated with at least one of remediating attentional state and the clinical symptoms of poor attentional state; achieving a more calm state; or a greater regulation of the sleep/waking cycle.

The interactive behavioral training session is of sufficient intensity (length of session and complexity of task parameters) and of sufficient frequency over multiple sessions to create lasting behavioral changes in an individual's attentional state that generalizes to one's everyday life activities.

In another embodiment, the interactive behavioral training regimen could be administered to those healthy individuals who want to improve their cognitive performance into the superior range or to those suspected to be suffering (or suffered in the past or at risk for suffering in the future) from disorders of attention as detailed above. In both cases, the participant will perform the interactive behavioral training session until he achieves a pre-defined goal or benchmark, as defined by specified level of performance on the behavioral assessments. After such time, the participant is periodically assessed using the behavioral assessments and if the participant's performance on the particular interactive behavioral assessments falls below the predefined goal or benchmark, it will be recommended the participant recommence ore repeat interactive behavior training session.

The interactive behavioral training regimen may be performed prophylactically such as prior to an event requiring the participant to be in an optional attentional state. The interactive behavioral training regimen of the present invention may be performed as an adjunct to a pharmacological approach to remediating poor attentional state or to improve an individual's attentional state.

The present invention also provides a method for diagnosing the presence or severity of an attention state dysfunction in a participant. The participant's attentional state is assessed prior to administering the interactive behavioral training regimen to ascertain the participant's pre-training attentional state index. Then the interactive behavioral training regimen comprising at least one interactive training session, is administered to the participant. The participant's attentional state is reassessed during or after the completion of the interactive behavioral training regimen and/or during or after at least one interactive training session to obtain a mid- or post-training attentional state index for the participant. A comparison is made of the participant's pre-attentional state index against the particpant's mid- and/or post-attentional state index and optionally compared against a predetermined benchmark. The presence or severity of the attentional state dysfunction in the participant is based on these comparisons. For example, if a participant is suspected as having ADHD, the participant is assessed as described above, and his results are compared to a previously defined benchmark. If the participant falls below this benchmark, then he is diagnosed with ADHD. Further, the comparison of the assessments before and after the training regimen can be used to diagnose the participant's ability to improve his attentional state and if the participant's improvement results fall below the norm or below a predetermined benchmark, then this information can be used to diagnose the participant's type or level of dysfunction.

The present invention also provides an attentional state enhancement interactive behavioral training system comprising task parameters as described above. The system comprises: a) a means for presenting to a participant a continuous sequence of stimuli groups at a specific duration separated by a variable inter-stimulus interval (ISI); wherein the stimuli groups contains both target stimuli and foil stimuli; b) a means for receiving a response from the participant reacting to the stimuli; and c) a means for recording the participant's response, wherein the response comprises a “response withholding” response or a “response switching” response. In another embodiment, the attentional state enhancement interactive behavioral training system also has a means for assessing the participant's response; and a means for altering the task parameters based on the participant responses.

The present invention also provides a computer-implemented interactive behavioral training system comprising: a) a central processing unit and b) a memory, coupled to the central processing unit where the memory stores a computer program mechanism. The computer program mechanism comprises a data repository that comprises: 1) a stimuli presenting module configured to provide a continuous sequence of stimuli groups at a specific duration for presentation to the subject; 2) a variable inter-stimulus interval (ISI) module configured to vary the interval between the presentation of the stimuli groups; and 3) a response time variability module configured to measure the variability in the participants' response time; and 4) a recording module configures to record participant responses; 5) optionally a module or modules configured to measure mean response time; to measure commission accuracy; to measure response time; to measure vigilance decrement; to measure accuracy for target or foil avoidance; to measure target accuracy amongst distracters and/or to measure omission accuracy; and 6) optionally a module or modules configured to alter a training session by altering one or more task parameters selected from the group consisting of altering stimulus discrimination; altering duration of stimulus presentation; altering the stimulus; altering complexity/difficulty of discrimination task; altering ISI duration; altering rule complexity; altering the variance of inter-stimulus interval; altering stimuli novelty; altering spatial distracters; altering presence of spatial distractors; altering similar or dis-similar foils, altering frequency of targets presented versus foils, and altering location or type of stimulus.

In certain embodiments, the system further comprises an assessment module for assessing participant responses.

The present invention also provides a computer accessible memory medium for carrying out an interactive behavioral training session to enhance the attentional state in a participant. The medium comprises program instructions utilizing a computing device to:

a) provide a set of stimuli groups for presentation to the participant, wherein each stimulus group is presented for a specified duration, and wherein the stimulus group in the continuous sequence of stimulus groups are separated by a specified variability in inter-stimulus-interval (ISI);

b) record a response from the participant for each stimulus group;

c) assess the response from the participant;

d) adjust the duration ISI variability based on the participant's response;

e) optionally adjusting additional interactive behavioral training session task parameters selected from the group consisting of target frequency, presence/absence of distractors, similarity between target and foil and/or spatial location of presentation based on said determining, wherein said adjusting the duration, target frequency, presence/absence of distractors, similarity between target and foil and/or spatial location of presentation is performed using an adaptive procedure; and

f) optionally repeat steps a-e one or more times in an iterative manner to improve the attentional state of the person. In certain embodiments, the program instructions are executable by a processor.

The medium of the interactive behavioral exercises and training could be on a desktop computer or laptop in a supervised setting (e.g., clinic or laboratory), at a individual's home or on a portable device such as a cell phone, smart phone, or other mobile computerized device (e.g., iPhone, iPod, iPad, Android phone, wearable remote monitoring devices).

The means for presenting to a person a continuous sequence of stimuli groups; the means for receiving a response from the participant; and the means for recording the participant's response can be a computer, a LAN, a WAN or the Internet.

In certain embodiments the invention provides a method for implementing an interactive behavioral training session for enhancing a participant's attentional state by delivering computer readable instructions. The method comprises transmitting, over a signal transmission medium, signals representative of a set of stimuli groups for presentation to the participant, wherein each stimulus group is presented for a specified duration, and wherein the stimulus groups are separated by a specified variability in inter-stimulus-interval (ISI). The method further entails receiving, from a signal transmission medium, signals representative of the participant's response to the stimuli groups, and recording the responses to the stimuli groups. The method also involves assessing the recorded response from the participant and adjusting the ISI variability and optionally adjusting additional task parameters. The method then entails transmitting, over a signal transmission medium, signals representative of a set of stimuli groups for presentation to the participant, wherein the stimulus group in the continuous sequence of stimulus groups are separated by an altered or adjusted specified variable inter-stimulus-interval (ISI).

The invention can be implemented in digital electronic circuitry, or in computer hardware, firmware, software, or in combinations thereof Apparatus of the invention can be implemented in a computer program product tangibly embodied in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language. Suitable processors include, by way of example, both general and special purpose microprocessors. Generally, a processor receives instructions and data from a read-only memory and/or a random access memory. A computer can include one or more mass storage devices for storing data files;

such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD_ROM disks. Any of the foregoing can be supplemented by, or incorporated in, ASTCs (application-specific integrated circuits).

In addition, the present invention provides a system having a computer, one or more databases containing the groups of stimuli, devices to receive and record responses, and a communication link connecting the computer to the one or more databases. In this system, data may be input by downloading from a local site such as a memory or a disk drive, or alternatively from a remote site over a network such as the Internet.

Certain embodiments of the invention are embodied both as a procedure and as a computer program product embodied on a computer-usable medium that includes computer readable code means for performing the procedure. The computer-usable medium may be a removable medium such as a diskette or a CD, or it may also be a fixed medium, such as a mass storage device or a memory.

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the scope of the following claims.

### EXAMPLES

### Example 1

Tonic and Phasic Attention Training (TAPAT) Improves Attention in Hemispatial Neglect

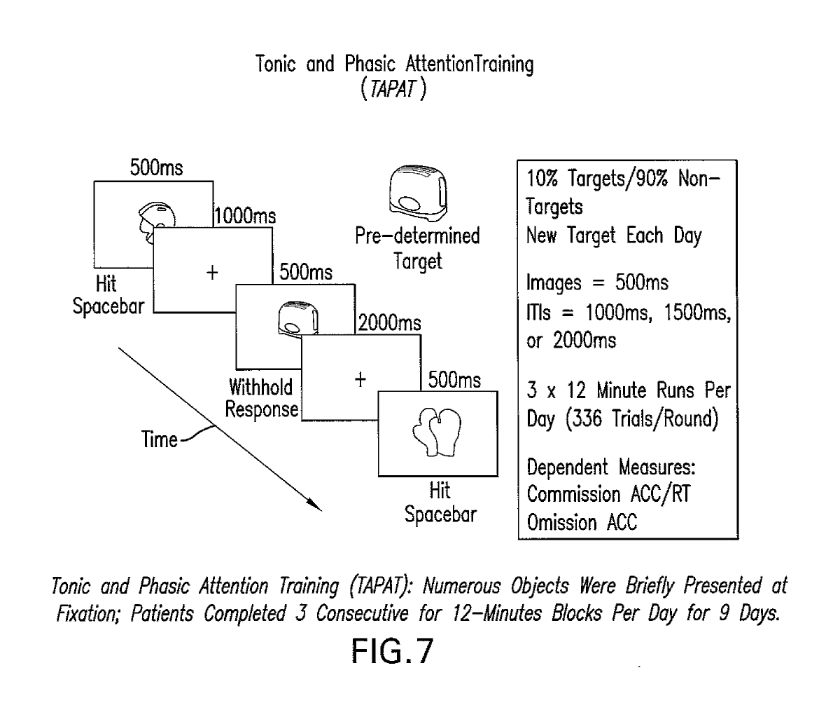

For hemispatial neglect, a debilitating stroke disorder in which patients do not attend to information on the opposite side of space as their brain lesion, we developed a version of the interactive behavioral training task that patients could perform with a moderate amount of success. Patients performed 3, 12-minute blocks of the training task that we named ‘Tonic and Phasic Alertness Training’ or TAPAT (because it trains both moment-to-moment and extended aspects of alertness, DeGutis & VanVleet, 2010) once a day for 9-days. The session began with patients familiarizing themselves with the target scene (see FIG. 7) and reading the following instructions: “You will see many scenes over the next 12 minutes. Your job is to hit the spacebar as fast as you can for each scene except when the scene is the target scene. When you see the target scene, don't hit the spacebar.” In each block, centrally presented scenes were briefly displayed (500 ms) such that spatial attention and/or eye movements were unnecessary. Also, presentation of the target scene was non-predictive and infrequent, not allowing the need to develop an executive strategy. Patients were simply required to sustain attention to the task over 36-minutes, responding quickly to all non-target scenes and attempting to inhibit the prepotent motor response when they saw a target scene. The scenes were photographs of common environments encountered within daily life such as grocery store, bathroom, park, kitchen. Target scenes appeared on only 10% of trials and objects were separated by a fixation “+” that appeared at central fixation and at random intervals of 100 0ms (33.3% of trials), 1500 ms (33.3% of trials), or 2000 ms (33.3% of trials). After completion of 360 trials, patients took a short break (approximately 1 minute) before beginning the next 12-minute block of 360 trials, for a total of 1080 trials each day.

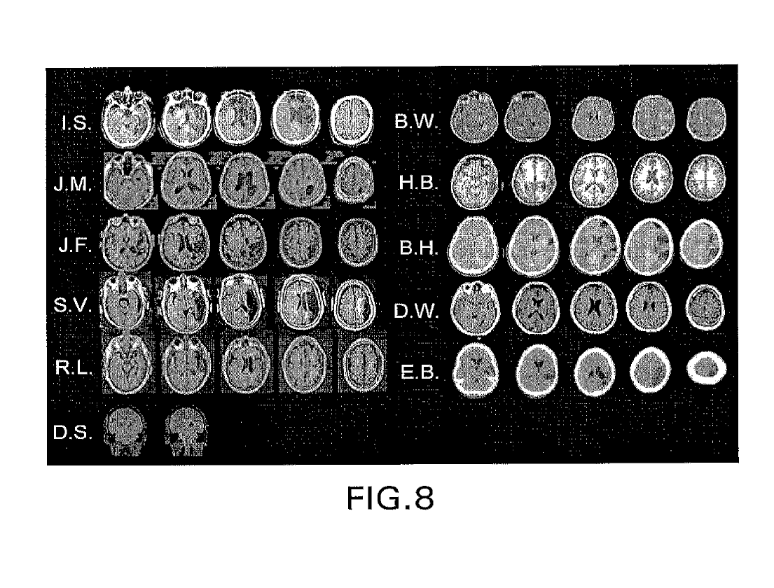

In this study (DeGutis & Van Vleet, 2010), we ran 12 chronic neglect patients (>6 months post-stroke/trauma; see FIG. 8, age range was 23-76 years old (M=56) and all patients were right-handed. These patients presented with a variety of etiologies/lesion types: 1 tumor resection, 4 traumatic brain injury, 7 middle cerebral artery infarction. The lesion locations included: frontal (9), parietal (12), subcortical (5), and occipital (1).

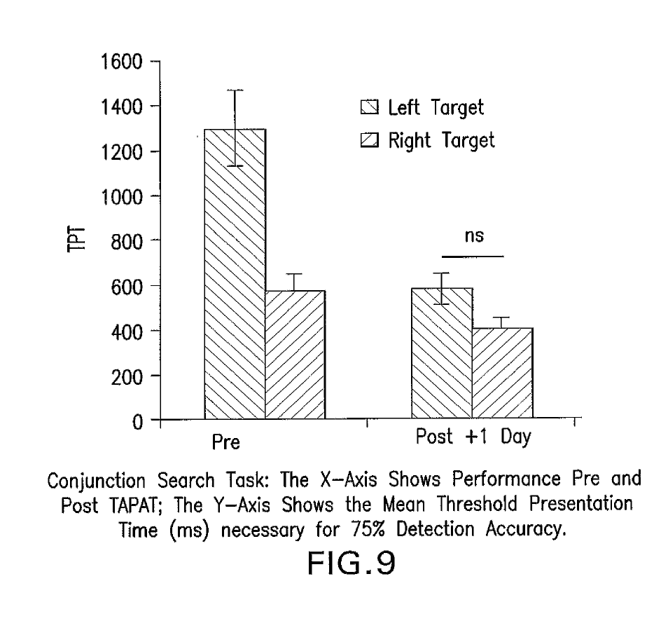

Comparing performance on the first and final day of TAPAT, 10 of 12 patients significantly improved on at least one component of the training task: 6 of 12 significantly improved commission accuracy to non-targets, 4 of 12 significantly improved omission accuracy to targets, and 8 of 12 significantly improved reaction time for correct commissions to non-targets. Training-related effects on behavior were examined using well-validated computer-based tests of attention: 1) visual search: conjunction search task (CS); 2) subjective midline estimation/object-based attention: landmark task (LM); and 3) working memory: attentional blink task (AB). Prior to training, all 12 patients tested were significantly slower at finding targets on the left compared to the right (see FIG. 9). This group-level impairment is consistent with previous studies and indicates a moderate to severe level of attentional impairment. After TAPAT (Post+1 day), patients significantly improved at detecting targets on the left and failed to show a significant difference between detection speed for targets on the left v. right side of the screen. This group-level effect shows that TAPAT is potent, as patients' symptoms on a sensitive CS measure were effectively abolished.

Correlation analyses showed that severity of pre-training search performance was positively correlated with level of improvement post-training; this suggests that patients with more severe deficits in attention showed greater improvement post-training compared to patients with less severe search deficits. Multiple regression analyses examining subcomponents of the TAPAT and outcome on conjunction search revealed a significant trend (p=0.08) of improvement in omission accuracy (i.e., target accuracy or withholding response to a target scene) on TAPAT to predict improvements in search independent of commission accuracy (i.e., responding to nontarget scenes) or reaction time (RT). This finding suggests that response inhibition is a powerful predictor of post-training improvements in search and a potentially crucial component of the training.

The magnitude of the training effect on search efficiency was unexpected given the limited number of days spent on the task. Remarkably, when patients spent the same amount of time on an active control condition which consisted of looking for a target item located within the same scenes used in TAPAT, they failed to show any beneficial effect (scenes were enlarged to increase spatial extent and flashed at a similar rate as that used in the TAPAT). The critical difference between the control task and TAPAT appears to be the cognitive operation that is trained: non-spatial, sustained attention and response monitoring (i.e., response inhibition) in TAPAT and spatial attention/search in the ineffective control version. These data demonstrate that practicing as specific attentional skill (search) does not necessarily improve attentional capacity, but engaging in a non-spatial, sustained attention task (TAPAT) does.

The average longevity of the training effect varied between 2-4 weeks post completion of TAPAT across patients. At the group level, improvements in CS faded by Post+14 days and the difference between detecting left and right targets were not significantly different from pre-training baseline. While outside the scope of the current proposal, the question remains: would training to specific criteria (e.g., symmetrical search performance) or simply training longer, more frequent or repeatedly over months produce a more lasting effect? Preliminary data indicates that training to specific criteria does appear to produce a longer effect (VanVleet & DeGutis, single case study in prep).

Patients also improved on the LM task, a measure of the allocation of visual attention across an object (an indicator of patients' midline estimation). After TAPAT, subjective midpoint estimation shifted significantly to the left, and approximates the slightly leftward bias of normal controls. This consistent shift in object-based attention contrasts the inconsistent object-based attention results by Sturm and colleagues.

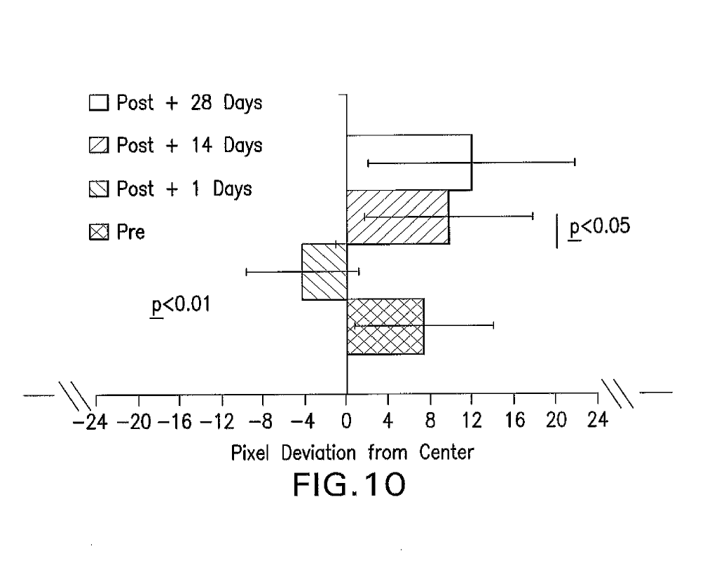

Prior to training, patients demonstrated significantly impaired discrimination accuracy for the second target in an AB task, consistent with previous reports (VanVleet & I. Robertson, 2006). Following training, T2 discrimination accuracy significantly increased (Pre TAPAT 62% v. Post TAPAT=82%) suggesting that TAPAT improves the selective allocation of attention. Improvements in the AB decreased slightly at 2 weeks post-TAPAT (Time 3) relative to Post+1 day (Time 2), but did not drop to pre TAPAT accuracy levels (Time 1=62% v. Time 3=73%; see FIG. 10). Multiple regression analyses showed that commission accuracy (non-target discrimination on the TAPAT) independently accounted for a significant portion of the variability in improvement when targets occur closely in time (lag 2; p−0.006), while RT showed a trend toward predicting the variability in improvement (p=0.079). This finding suggests that improvements in speed and accuracy in TAPAT translate to the AB task, particularly at short time intervals between targets (i.e., at greater discrimination difficulty).

### Example 2

Cross-Training in hemispatial neglect: auditory tonic and phasic attention training improves visual attention.

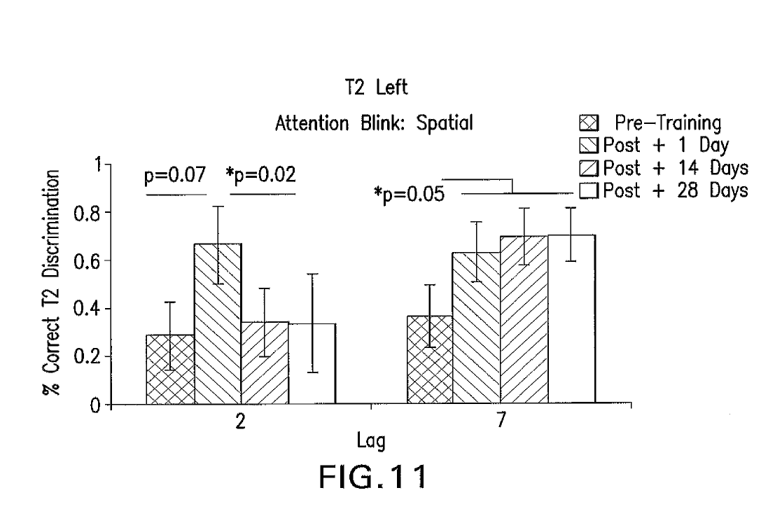

In a follow-up experiment, we tested whether the training-related effects in neglect patients from example 1 would replicate if the training task stimuli were from the auditory modality (Van Vleet and DeGutis, submitted). If so, this suggests that the mechanism of training is from enhancing an individual's, attentional state rather than training any sensory-specific skill. Specifically, 8 neglect patients trained to identify a target tone amongst distractor tones for 9 days. FIG. 11 shows that patients' spatial and temporal attention improved after auditory training, with the greatest improvement reflected in patients' most impaired portion of space-time.

### Example 3

TAPAT Improves Cognition In Older Adults

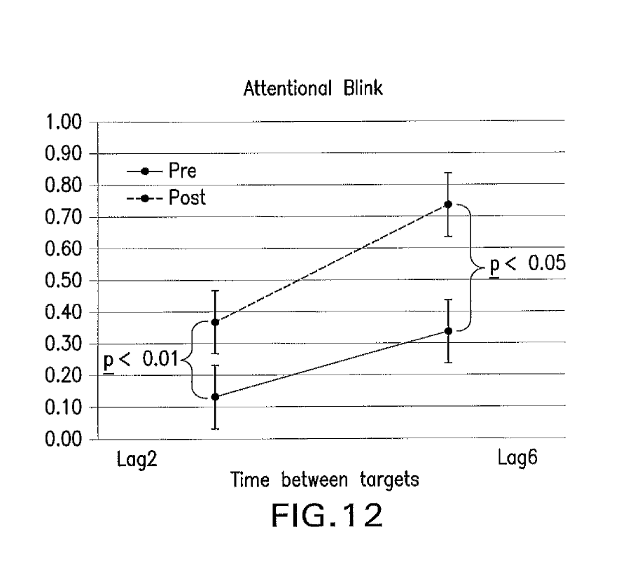

An additional study in a group of 14 senior citizen participants (mean age=79), 4 hours of TAPAT training over 9 days (24 min/day) produced significant improvements in sensitive outcome measures of attention, working memory, and executive function compared to an active control group (Van Vleet et al, in prep). As discussed above, to push the limits of perceptual resolution and working memory, all characters were presented rapidly at central fixation: two target numbers embedded in a serial stream of 14 letters. Each character was presented on the screen for 80 ms with a 20 ms inter-stimulus interval (see FIG. 12). Prior to TAPAT participants demonstrated significantly impaired discrimination accuracy for the second target, consistent with earlier reports. Poor second target accuracy has been attributed to the refractory period that follows a phasic burst in LC activity associated with correct discrimination of the first target (normally 300 ms). Following TAPAT, T2 discrimination accuracy significantly increased (Pre TAPAT=22% v. Post TAPAT=64%) indicating that TAPAT training improves the selective allocation of attention and working memory. A test-retest, age-matched control group (n=6) failed to show any improvement in accuracy when retested. Theoretically, the increase in T2 accuracy may result from a normalization of the LC refractory period due to TAPAT training, enabling earlier phasic activation to the second target. This change may reflect greater efficacy of the alerting network indicating that TAPAT training was effective in targeting this fundamental aspect of attention. Finally, improvement in this task is particularly striking given the poor, normative performance reported on this task compared to younger individuals.

Participants also demonstrated significant improvement on standardized measures of working memory and executive function compared to an age-matched normative sample: letter-number sequencing task (pre-TAPAT z-score=0.67 v. post-TAPAT z-score=1.00, p<0.05); and verbal fluency (pre-TAPAT z-score=−0.67 v. post-TAPAT z-score=−0.25, p<0.05). Participants in an active control condition exhibited no difference post-control task. Importantly, participants in the study reported no disruption of sleep or increase in fatigue; several participants reported feelings of increased vigilance and focus throughout the day, post-training. All participants felt that the requirements of the task were manageable, allowing them to engage on a daily basis.

### Example 4

TAPAT Improves Learning Rate In Healthy Controls

Additional preliminary data from two small groups (n=3 per group) suggest that TAPAT training preceding other targeted attentional skills training procedures may improve learning rate and outcomes on these specific skills. For example, participants who completed 12-minutes of

TAPAT training before engaging in a working memory training task (multiple object tracking) showed a trend toward faster acquisition of the skill and greater capacity of items tracked (mean number of items tracked=3.71) following 10-hours of training compared a group that engaged in the working memory training alone (mean number of items tracked=3.06). Similar effects were seen on a perceptual learning task preceded by TAPAT, compared to performance of participants that engaged in the perceptual learning task alone.

### Example 5

TAPAT Induces a Right-Hemisphere Perceptual Bias In Healthy Controls

Published data from our lab (Van Vleet, Hoang-duc, DeGutis & Robertson, 2010) indicates that following only 16-minutes of visual TAPAT training, young healthy control particpants exhibit a right hemisphere perceptual bias on a nested letter task. This is strong evidence that TAPAT training has effects on young healthy control subjects and induces greater activation in the right hemisphere, regions intimately involved in sustaining an optimal attentional state.

### Example 6

TAPAT improves attention in veterans suffering from traumatic brain injury and post-traumatic stress disorder.

Preliminary data from an ongoing study suggests that TAPAT training, using similar parameters to those used with neglect patients in example 1, can also enhance cognition in veterans suffering from traumatic brain injury and post-traumatic stress disorder. We are finding training-related improvements in working memory, sustained attention, and executive function.

### REFERENCES

DeGutis, J & Van Vleet, T (2010). Tonic and Phasic Alertness Training: a novel behavioral therapy to improve spatial and non-spatial attention in patients with hemispatial neglect. Frontiers in Human Neuroscience, 4(60), 1-17.

Robertson I H, Mattingley J B, Rorden C, Driver J. (1998) Phasic alerting of neglect patients overcomes their spatial deficit in visual awareness. Nature. Sep 10; 395(6698):169-72.

Ryan M, Martin R, Denekla M B, Mostofsky S H, Mahone E M. (2010) Interstimulus jitter facilitates response control in children with ADHD. J Int Neuropsychol Soc. Mar; 16(2):388-93.

Sohlberg M M, Mateer C A. (2001). Improving attention and managing attentional problems. Adapting rehabilitation techniques to adults with ADD. Ann N Y Acad Sci. Jun; 931:359-75.

Sturm W, Orgab B, Hartje, W. (2001). AixTent: A Computerized Training of Four Attention Functions. A Training of Alertness, Vigilance, Selective Attention, Divided Attention. Phoenix Software GmbH (www.phnxsoft.com).

Van Vleet T M, Robertson L C. (2006) Cross-modal interactions in time and space: auditory influence on visual attention in hemispatial neglect. J Cogn Neurosci. Aug; 18(8):1368-79.

Van Vleet, T, Hoang-duc, A, DeGutis, J & Robertson, L (2010). Modulation of non-spatial attention and the global/local processing bias. Neuropsychologia, 49, 352-359.

Van Vleet T M and DeCutts J M (submitted) Cross-Training in hemispatial neglect: auditory tonic and phasic attention training improves visual attention.

1. An interactive behavioral training session comprising task parameters, the session comprising:
a) presenting to a participant a continuous sequence of stimuli groups at a specific time duration, wherein the stimuli groups comprise at least one target event or foil event at a specific time duration,
wherein the stimuli groups are separated in time by a variable inter-stimulus interval (ISI); and
b) requiring the participant to provide a response comprising an input upon sensing the at least one target event or foil event;
wherein the interactive behavorial training session is of sufficient intensity to create an enduring behavioral change in modulatory functions of attention and to achieve an enhanced attentional state in the participant;
c) assessing the participant's attentional state prior to administering the interactive behavioral training regimen to ascertain the participant's pre-training attentional state index and/or assessing the participant's attentional state during the interactive behavioral training regimen to ascertain the participant's mid-training attentional state index;
d) optionally adjusting the interactive behavioral training session task parameters, selected from the group consisting of the variable inter-stimulus interval (ISI), target frequency, presence/absence of distractors, similarity between target and foil and/or spatial location of presentation based on said determining, wherein said adjusting the duration, target frequency, presence/absence of distractors, similarity between target and foil and/or spatial location of presentation is performed using an adaptive procedure; wherein the adjustment to the task parameters is based on the pre-training and/or mid-training attentional state index;
wherein the adjustment to the task parameters is based on the assessment in step c); and
e) optionally repeating steps a-d one or more times in an iterative manner to improve the attentional state of the participant.

2. The interactive behavioral training of claim 1 wherein the task parameters comprise stimulus discrimination, stimulus discrimination difficulty, duration of stimulus presentation, complexity/difficulty of the response rule, complexity/difficulty of discrimination task, stimulus novelty, presence of spatial distracters of similar or dissimilar foils, target frequency versus foil frequency, and location or type of stimulus, correspondence frequency, and target/foil confusability.

3. A method for enhancing the attentional state of a participant comprising at least one interactive behavioral training session comprising task parameters, the method comprising:
a) presenting to a participant a continuous sequence of stimuli groups at a specific time duration, wherein the stimuli groups comprise at least one target event or foil event at a specific time duration,
wherein the stimuli groups are separated in time by a variable inter-stimulus interval (ISI); and
b) requiring the participant to provide a response comprising an input upon sensing the at least one target event or foil event;
wherein the interactive behavorial training program is of sufficient intensity to create an enduring behavioral change in modulatory functions of attention and to achieve an enhanced attentional state in the participant.

4. The method of claim 3 wherein the task parameters comprise stimulus discrimination, stimulus discrimination difficulty, duration of stimulus presentation, complexity/difficulty of the response rule, complexity/difficulty of discrimination task, stimulus novelty, presence of spatial distracters of similar or dissimilar foils, target frequency versus foil frequency, and location or type of stimulus, correspondence frequency, and target/foil confusability.

5. The method of claim 3 wherein the response is selected from the group consisting of:
a) providing a first input upon sensing all foil events and withholding the first input upon sensing the target events;
b) providing a first input upon sensing all foil events and providing a second input upon sensing a target event, wherein the first and second inputs are different;
c) providing a first input upon sensing only target events and withholding the first input upon sensing a foil; or
d) mixtures of a, b and c.

6. The method of claim 3 wherein the stimuli group comprises more than one target event and/or foil event or mixtures thereof, and optionally wherein the more than one target and/or foil event or mixtures thereof are separated in time by a variable inter-event interval (IVI) time.

7. The method of claim 3 further comprising assessing the participant's attentional state prior to administering the interactive behavioral training regimen to ascertain the participant's pre-training attentional state index; wherein the assessing is performed by:
a) a repeated behavorial assessment battery;
b) the interactive behavioral training session of claim 4;
c) physiological and/or real-world assessments or mixtures thereof; or
d) mixtures of a, b and c.

8. The method of claim 7 further comprising reassessing the participant's attentional state during the interactive behavioral training regimen and/or during the at least one interactive training session to obtain a mid-training attentional state index.

9. The method of claim 8 further comprising adjusting the interactive training session and/or interactive behavioral training regimen based on the person's mid-attentional state index.

10. The method of claim 9 further comprising reassessing the participant's attentional state after the completion of the interactive behavioral training regimen and/or after the at least one interactive training session to obtain a post-training attentional state index for the participant.

11. The method of claim 10 wherein the assessing of the participant's pre- mid- or post-training attentional state comprises measuring the reaction time variability, accuracy, reaction time, or decrement associated with the response or mixtures thereof.

12. The method of claim 11 wherein the adjusting the interactive behavioral training session comprises altering one or more task parameters based on the participant's pre-, mid- or post training attentional state index.

13. The method of claim 12 wherein the adjusting the interactive training session comprises altering the variable inter-stimulus interval (ISI), and/or altering additional task parameters.

14. The method of claim 3 wherein the modulatory functions of attention include an alteration of norepinephrine and dopamine levels to a more balanced state; increased alterness, increased focus and freedom from distraction; increased behavorial control, greater short-term memory capacity, improved decision making ability, enhanced learning ability, increased capacity to regulate one's emotional responses, enhanced spatial attention and improved motor control, memory retention, the ability to learn in a faster and more efficient manner, optimized function in modulatory neurotransmitters including serotonin, norepinephrine, dopamine and acetylcholine; improved ability to respond to stimuli without a significant decrease in performance over time; appropriate release of modulatory neurotransmitters associated with at least one of remediating attentional state and the clinical symptoms of poor attentional state; achieving a more calm state; or a greater regulation of the sleep/waking cycle.

15. A method for diagnosing the presence or severity of an attention state dysfunction in a participant, the method comprising:
1) assessing the participant's attentional state prior to administering the interactive behavioral training regimen to ascertain the participant's pre-training attentional state index; wherein the assessing is performed by:
a) a repeated behavorial assessment battery;
b) the interactive behavioral training session of claim 1;
c) physiological and/or realworld assessments or mixtures thereof; or
d) mixtures of a, b and c.
2) administering to the participant an interactive behavioral training regimen comprising at least one interactive behavioral training session comprising task parameters, the training session comprising:
a) presenting to a participant a continuous sequence of stimuli groups at a specific time duration, wherein the stimuli groups comprise at least one target event or foil event at a specific time duration, wherein the stimuli groups are separated in time by a variable inter-stimulus interval (ISI); and
b) requiring the participant to provide a response comprising an input upon sensing the at least one target event or foil event;
wherein the interactive behavioral training program is of sufficient intensity capable of creating an enduring behavioral change in modulatory functions of attention and achieve an enhanced attentional state in a participant without an attention dysfunction;
3) reassessing the participant's attentional state during or after the completion of the interactive behavioral training regimen and/or during or after the at least one interactive training session to obtain a mid- or post-training attentional state index for the participant;
4) comparing the participant's pre-attentional state index with the particpant's mid- and/or post-attentional state index and optionally comparing the paticipant's mid- and/or post-attentional state index with a predetermined benchmark; and
5) determining the presence or severity of the attentional state dysfunction in the participant based on the comparison in step 4.

16. An attentional state enhancement interactive behavioral training system comprising task parameters; the system comprising
a) a means for presenting to a participant a continuous sequence of stimuli groups at a specific duration separated by a variable inter-stimulus interval (ISI); wherein the sequence of stimuli groups contains both target stimuli and foil stimuli;
b) a means for receiving a response from the participant reacting to the stimuli;
c) a means for recording the participant's response, wherein the response comprises response withholding response or a response switching response;
wherein the task parameters comprise variable inter-stimulus interval (ISI) and further comprise factors selected from the group consisting of stimulus discrimination, duration of stimulus presentation, complexity/difficulty of discrimination task, stimulus novelty, presence of spatial distracters of similar or dissimilar foils, target frequency versus foil frequency, and location or type of stimulus.

17. The attentional state enhancement interactive behavioral training system of claim 15, further comprising;
d) a means for assessing the participant's response; and
e) a means for altering the task parameters based on the participant's response.

18. A computer-implemented interactive behavioral training system comprising:
a) a central processing unit;
b) a memory, coupled to the central processing unit, the memory storing a computer program mechanism, the computer program mechanism comprising a data repository comprising:
1) a stimuli presenting module configured to provide a continuous sequence of stimuli groups at a specific duration for presentation to the subject;
2) a variable inter-stimulus interval (ISI) module configured to vary the interval between the presentation of the stimuli groups; and
3) a response time variability module configured to measure the variability in a participant's response time; and
4) a recording module configured to record participant responses;
5) optionally a module or modules configured to measure mean response time; to measure commission accuracy; to measure response time; to measure vigilance decrement; to measure accuracy for target or foil avoidance; to measure target accuracy amongst distracters and/or to measure omission accuracy; and
6) optionally a module or modules configured to alter a training session by altering one or more task parameters selected from the group consisting of altering stimulus discrimination; altering the stimulus; altering ISI duration; altering rule complexity; altering the variance of inter-stimulus interval; altering stimuli novelty; altering spatial distracters; altering similar or dis-similar foils and altering frequency of targets presented versus non-targets.

19. The system of claim 18 further comprising an assessment module for assessing participant responses.

20. The system of claim 19 further comprising module for altering the task parameters based on the assessment of the participant's responses.

21. A computer accessible memory medium for carrying out an interactive behavioral training session to enhance the attentional state in a participant, the medium comprising program instructions utilizing a computing device to:
a) provide a set of stimuli groups for presentation to the participant, wherein each stimulus group is presented for a specified duration, and wherein the stimulus group in the continuous sequence of stimulus groups are separated by a specified variability in inter-stimulus-interval (ISI);
b) record a response from the participant for each stimulus group;
c) assess the response from the participant;
d) adjust the duration ISI variability based on the assessment in step c,
e) optionally adjusting at least one additional interactive behavioral training session task parameters selected from the group consisting of target frequency, presence/absence of distractors, similarity between target and foil and/or spatial location of presentation based on said determining, wherein said adjusting the duration, target frequency, presence/absence of distractors, similarity between target and foil and/or spatial location of presentation is performed using an adaptive procedure; wherein the adjustment is based on the assessment in step c; and
f) optionally repeating steps a-e one or more times in an iterative manner to improve the attentional state of the person;
wherein the program instructions are executable by a processor.

22. The attentional state enhancement interactive behavioral training system of claim 16 wherein the means for presenting to a person a continuous sequence of stimuli groups; the means for receiving a response from the participant; and the means for recording the participant's response are performed using a computer, a LAN, a WAN or the Internet.

23. A method for implementing an interactive behavioral training session for enhancing a participant's attentional state by delivering computer readable instructions, the method comprising:
a) transmitting, over a signal transmission medium, signals representative of a set of stimuli groups for presentation to the participant, wherein each stimulus group is presented for a specified duration, and wherein the stimulus group in the continuous sequence of stimulus groups are separated by a specified variability in inter-stimulus-interval (ISI);
b) receiving, from a signal transmission medium, signals representative of the participant's response to the stimuli groups, and recording the responses to the stimuli groups;
c) assessing the response from the participant and adjusting the duration ISI variability based on the response; and
d) transmitting, over a signal transmission medium, signals representative of a set of stimuli groups for presentation to the participant, wherein the stimulus group in the continuous sequence of stimulus groups are separated by an altered specified variable inter-stimulus-interval (IS!) from c.

24. A computer system for enhancing the attentional state in a participant comprising: one or more processors configured to execute program instructions; and a computer-readable medium containing executable instructions that, when executed by the one or more processors, cause the computer system to perform a method for enhancing the attentional state in the participant, the method comprising:
a) presenting to a participant a continuous sequence of stimuli groups at a specific time duration, wherein the stimuli groups comprise at least one target event or foil event at a specific time duration,
wherein the stimuli groups are separated in time by a variable inter-stimulus interval (ISI); and
b) requiring the participant to provide a response comprising an input upon sensing the at least one target event and/or foil event;
wherein the interactive behavorial training program is of sufficient intensity to create an enduring behavioral change in modulatory functions of attention and to achieve an enhanced attentional state in the participant; and
c) optionally assessing the participant's attentional state prior to administering the interactive behavioral training regimen to ascertain the participant's pre-training attentional state index and/or assessing the participant's attentional state during the interactive behavioral training regimen to ascertain the participant's mid-training attentional state index;
d) optionally adjusting the interactive behavioral training session task parameters selected from the group consisting of the variable inter-stimulus interval (ISI), target frequency, presence/absence of distractors, similarity between target and foil and/or spatial location of presentation based on said determining, wherein said adjusting the duration, target frequency, presence/absence of distractors, similarity between target and foil and/or spatial location of presentation is performed using an adaptive procedure; wherein the adjustment to the task parameters is based on the pre-training and/or mid-training attentional state index;
wherein the adjustment to the task parameters is based on the assessment in step c); and
e) optionally repeating steps a-d one or more times in an iterative manner to improve the attentional state of the participant.

25. A computer-implemented method for enhancing the attentional state of a participant, the method comprising the system of claim 16.

26. A computer program product, comprising a tangible computer readable medium comprising executable instructions for effecting the following steps:
a) presenting to a participant a continuous sequence of stimuli groups at a specific time duration, wherein the stimuli groups comprise at least one target event or foil event at a specific time duration,
wherein the stimuli groups are separated in time by a variable inter-stimulus interval (ISI); and
b) requiring the participant to provide a response comprising an input upon sensing the at least one target event or foil event;
wherein the interactive behavorial training session is of sufficient intensity to create an enduring behavioral change in modulatory functions of attention and to achieve an enhanced attentional state in the participant,
c) assessing the participant's attentional state prior to administering the interactive behavioral training regimen to ascertain the participant's pre-training attentional state index and/or assessing the participant's attentional state during the interactive behavioral training regimen to ascertain the participant's mid-training attentional state index;
d) optionally adjusting the interactive behavioral training session task parameters, selected from the group consisting of the variable inter-stimulus interval (ISI), target frequency, presence/absence of distractors, similarity between target and foil and/or spatial location of presentation based on said determining, wherein said adjusting the duration, target frequency, presence/absence of distractors, similarity between target and foil and/or spatial location of presentation is performed using an adaptive procedure; wherein the adjustment to the task parameters is based on the pre-training and/or mid-training attentional state index;
wherein the adjustment to the task parameters is based on the assessment in step c); and
e) optionally repeating steps a-d one or more times in an iterative manner to improve the attentional state of the participant.

27. A non-transitory computer readable storage medium storing a computer program product which, when executed by at least one processor, causes the processor to perform the method of claim 3.
